(19) United States
(12) Patent Application Publication
(10) Pub. No.: US 2022/0233960 A1
(43) Pub. Date: Jul. 28, 2022

(54) RECORDING MEDIUM, CONTROL METHOD FOR GAME APPARATUS, AND GAME SYSTEM

(71) Applicant: Konami Digital Entertainment Co., Ltd., Tokyo (JP)

(72) Inventors: Shigeru CHIBA, Tokyo (JP); Kai INOUE, Tokyo (JP); Junki HIRAI, Tokyo (JP); Toshiaki KANAHARA, Tokyo (JP); Tsuguo SHINPO, Tokyo (JP); Akira SAKAI, Tokyo (JP)

(73) Assignee: Konami Digital Entertainment Co., Ltd., Tokyo (JP)

(21) Appl. No.: 17/717,204

(22) Filed: Apr. 11, 2022

Related U.S. Application Data
(63) Continuation of application No. PCT/JP2020/037099, filed on Sep. 30, 2020.

(30) Foreign Application Priority Data
Oct. 18, 2019 (JP) 2019-190853

(51) Int. Cl. A63F 13/61; A63F 13/86; A63F 13/79; G06Q 30/02

(52) U.S. Cl. CPC A63F 13/61; A63F 13/86; H04N 21/4532; G06Q 30/0261; G06Q 30/0269; A63F 13/79

(57) ABSTRACT

A non-transitory computer-readable recording medium having instructions stored therein causes at least one processor of a game apparatus to: communicate with a distribution system configured to distribute videos to a plurality of terminal apparatuses; progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

### CROSS REFERENCE TO RELATED APPLICATIONS

This application is a Continuation Application of PCT Application No. PCT/JP2020/037099, filed on Sep. 30, 2020, and is based on and claims priority from Japanese Patent Application No. 2019-190853 filed on Oct. 18, 2019, the entire contents of each of which are incorporated herein by reference.

### BACKGROUND

### Field of the Invention

The present disclosure relates to recording mediums, game apparatuses, control methods for game apparatuses and game systems.

### Description of Related Art

In recent years, video distribution services are widely used. In the video distribution services, videos are generally shown on video display areas that are parts of a web screen for video distribution. In addition, advertisements, such as banner ads, are shown for video viewers on advertisement display areas that are parts of the web screen, but are separate from the video display areas. In the field of games, a method is known in which advertisements are shown, for computer game players, on objects in a virtual space (e.g., Japanese Patent Application Laid-Open Publication No. 2002-253847).

Computer game users, as well as spectators who watch a computer game video, are targeted for distribution of computer game videos. For this reason, even when advertisements are shown on objects in a virtual space, it is expected to control content of the advertisements by looking at spectators. However, conventionally, content of advertisements are controlled without consideration of the presence of spectators watching the computer game video.

### SUMMARY

The present disclosure has been made in view of the situations described above, and it has as an object to control content of an advertisement to be displayed in a virtual space by looking at the presence of spectators of a computer game.

To achieve the stated object, a recording medium according to an aspect of the present enclosure is a non-transitory computer-readable recording medium having instructions stored therein that cause at least one processor of a game apparatus to: communicate with a distribution system configured to distribute videos to a plurality of terminal apparatuses; progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

A control method according to an aspect of the present enclosure is a computer-implemented control method includes including: communicating with a distribution system configured to distribute videos to a plurality of terminal apparatuses; progressing a computer game; generating, based on a progress of the computer game, video information that is used to play a video of the computer game indicating a state of a virtual space of the computer game; supplying a distribution video based on the video information to the distribution system; acquiring spectator information from the distribution system, the spectator information relating to at least one spectator apparatus that is a part of the plurality of terminal apparatuses, and receives the distribution video from the distribution system; and controlling content of an advertisement to be displayed in the virtual space, based on the spectator information.

A game apparatus according to an aspect of the present disclosure includes: at least one memory storing instructions and at least one processor that implements the instructions to: communicate with a distribution system configured to distribute videos to a plurality of terminal apparatuses; progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

A game system according to an aspect of the present disclosure includes: a distribution system configured to distribute videos to a plurality of terminal apparatuses; and a game apparatus configured to communicate with the distribution system, in which the game apparatus includes: at least one memory storing instructions; and at least one processor that implements the instructions to: progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

### BRIEF DESCRIPTION OF THE DRAWINGS

FIG. 1 is a diagram showing an overview of a game system according to an embodiment.

FIG. 2 is a diagram showing an example of an overview of a display-use video generated by a game apparatus shown in FIG. 1.

FIG. 3 is a diagram showing an example overview of a video distribution screen supplied by the distribution server to the terminal apparatus.

FIG. 4 is a functional block diagram of an example of the game apparatus shown in FIG. 1.

FIG. 5 is an example of hardware configuration of the game apparatus shown in FIG. 4.

FIG. 6 is a functional block diagram showing an example of the configuration of a distribution server shown in FIG. 1.

FIG. 7 is an example of a hardware configuration of the distribution server shown in FIG. 6.

FIG. 8 is a functional block diagram showing an example of a configuration of an advertisement management server shown in FIG. 1.

FIG. 9 is an example of a hardware configuration of the advertisement management server shown in FIG. 8.

FIG. 10 is a diagram showing an overview of spectator information.

FIG. 11 is an example of a data structure of a registrant management table.

FIG. 12 is an example of a data structure of an advertisement management table.

FIG. 13 is a sequence chart of example procedures for the game system shown in FIG. 1.

FIG. 14 is a flowchart showing an example of procedures for the game apparatus shown in FIG. 1.

FIG. 15 is an example of a data structure of an advertisement management table according to Modification 1.

FIG. 16 is an example of a data structure of an advertisement management table according to Modification 2.

FIG. 17 is a flowchart showing an example of procedures for the game apparatus according to Modification 6.

FIG. 18A is a diagram showing an overview of a game system according to Modification 8.

FIG. 18B is a functional block diagram of an example of a game server shown in FIG. 18A.

### DESCRIPTION OF THE EMBODIMENT

Hereinafter, modes for carrying out the present disclosure will be described with reference to the drawings. In each diagram, the dimensions and scale of each element are appropriately different from actual ones. The embodiment described below is preferable specific examples of the present disclosure. Accordingly, various technically preferable limitations are applied. However, the scope of the present disclosure is not limited to these modes unless there is a specific description limiting the present disclosure.

### 1. Embodiment

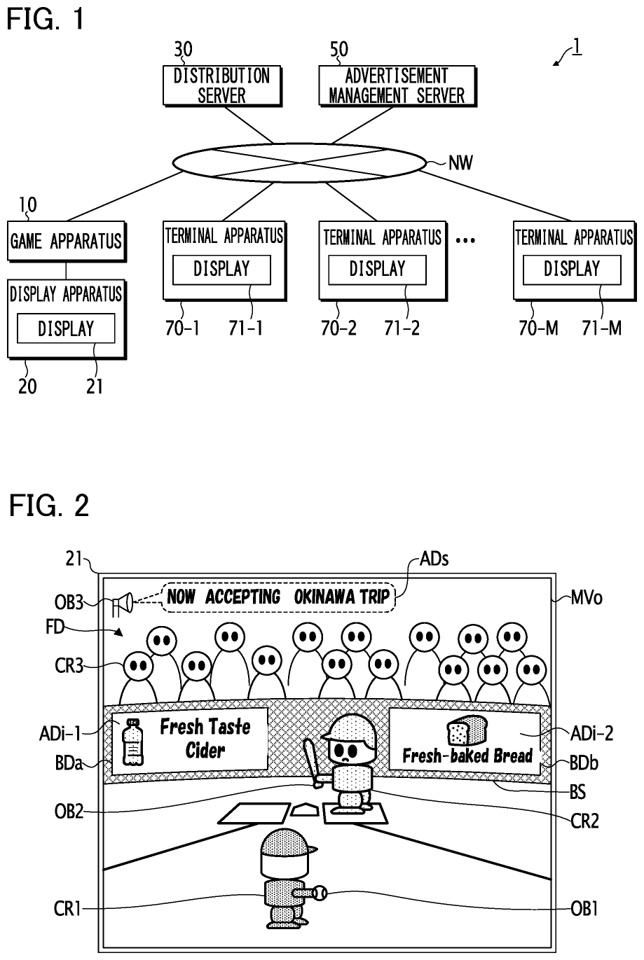

First, description will be given of an example outline of a game system 1 according to an embodiment with reference with FIG. 1.

FIG. 1 is a diagram showing an overview of the game system 1 according to the embodiment.

The game system 1 shown in FIG. 1 includes a game apparatus 10 that is executable for a predetermined computer game, a display apparatus 20 that corresponds to the game apparatus 10, a distribution server 30 (an example of a “distribution system”), an advertisement management server 50, and a plurality of M terminal apparatuses 70 (70-1 to 70-M). M is a natural number of 1 or more. In one example, the game apparatus 10, the distribution server 30, an advertisement management server 50, and the plurality of M terminal apparatuses 70 are connected communicably to one another via a network NW. In the following description, the m-th terminal apparatus 70 of the M terminals apparatuses 70-1 to 70-M is referred to as a terminal apparatus 70-m. The m is a natural number satisfying 1≤m≤M.

In one example, the game apparatus 10 displays, on a display 21 provided in the display apparatus 20 commutable with the game apparatus 10, a video of a predetermined computer game executed by the game apparatus 10. In this embodiment, an assumption will be made that a computer baseball game (an example of a “computer game”) is executed at the game apparatus 10.

In the following description, a video of a computer baseball game that is displayed on the display 21 by the game apparatus 10 is referred to as “display-use video GMV” (see FIG. 2). In this embodiment, the display-use video GMV is an example of a “video of a computer game.” In one example, the display-use video GMV may be a display-use still image, and it may be updated per unit period of time (e.g., 1/60th of a second). For each unit period of time, a display-use still image is displayed on the display 21.

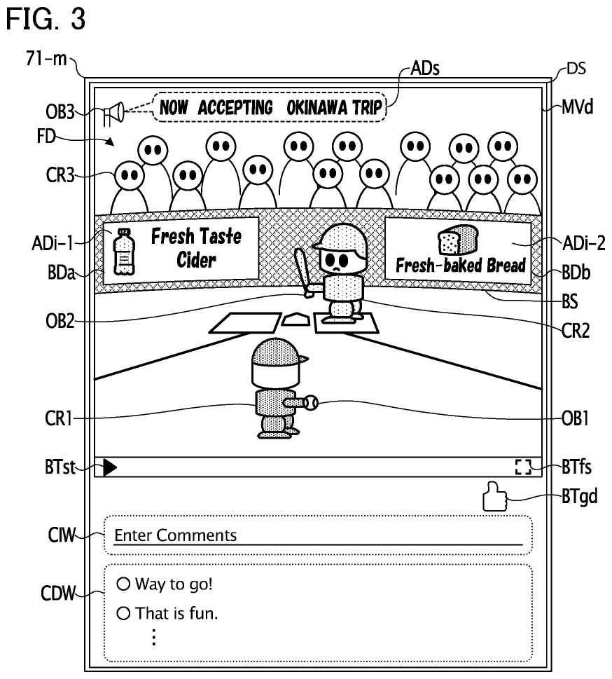

In this embodiment, the game apparatus 10 supplies, to the distribution server 30, a video of the computer baseball game executed at the game apparatus 10. In the following description, the video of the computer baseball game that is supplied by the game apparatus 10 to the distribution server 30 is referred to as “distribution-use video DMV” (see FIG. 3). In one example, the distribution-use video DMV may be a distribution-use still image, and may be updated per unit period of time. For each unit period of time, a distribution-use still image is supplied by the game apparatus 10 to the distribution server 30. For example, the distribution-use still image may have a lower resolution than the display-use still image, or it may be identical to the display-use still image.

In this embodiment, an assumption is made that a distribution-use video DMV is based on video information that is used to play a display-use video GMV, and the distribution-use video DMV and the display-use video GMV are identical to each other. However, the present disclosure is not limited to such an aspect. In one example, the distribution-use video DMV may have a lower resolution than the display-use video GMV.

In this embodiment, the distribution-use video DMV is an example of a “distribution video.”

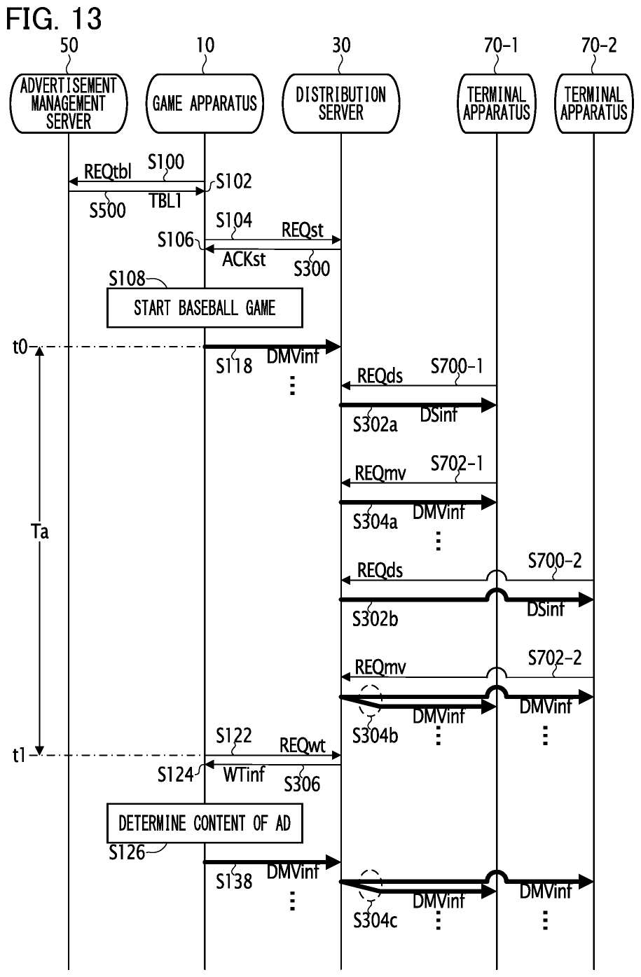

In one example, the game apparatus 10 supplies the distribution-use video DMV (specifically, the video information that is used to play the distribution-use video DMV) to the distribution server 30. Hereinafter, the video information that is used to play the distribution-use video DMV is referred to as “distribution-use video information DMVinf” (see FIG. 13). In this embodiment, video information that is used to play a display-use video GMV is not specifically shown in the drawings, but it is also referred to as “display-use information GMVinf” to be consistent with “distribution-use video information DMVinf.”

In this embodiment, an assumption will be made in which the game apparatus 10 is for home use. However, a freely selected information processing apparatus is used for the game apparatus 10. Examples of the game apparatus 10 include a commercial-use game device installed in a store or an amusement facility, a mobile device such as a cellar phone or a smart phone, and a stationary information device such as a personal computer. Examples of the display apparatus 20 include a liquid crystal display, a television receiver, and a touch panel display. The display apparatus 20 may be included in the game apparatus 10.

The distribution server 30 is an example of a distribution system that distributes a video, such as a distribution-use video DMV, to each of the terminal apparatuses 70. In one example, when receiving (i) a distribution-use video DMV from the game apparatus 10, and (ii) a distribution request of the distribution-use video DMV from a terminal apparatus 70-m, the distribution server 30 distributes, to the terminal apparatus 70-m, the distribution-use video DMV supplied form the game apparatus 10. Furthermore, when receiving, from the terminal apparatus 70-m, a distribution request of a video distribution screen DS that is used to display the distribution-use video DMV, the distribution server 30 distributes the video distribution screen DS to the terminal apparatus 70-m (see FIG. 3).

As will be described with reference to FIG. 13, the distribution server 30 may send, to the game apparatus 10, information (an example of “spectator information”) on the terminal apparatuses 70 playing the distribution-use videos DMV.

In an example shown in FIG. 1, the terminal apparatus 70-m includes a display 71-m. When the distribution-use video DMV is distributed from the distribution server 30, the terminal apparatus 70-m displays the distribution-use video DMV on a display 71-m. A freely selected information processing apparatus connectable with the Internet may be used for the terminal apparatus 70-m, examples of which include a smartphone, a cellar phone, and a personal computer.

In one example, the advertisement management server 50 supplies, to the game apparatus 10, information necessary for the game apparatus 10 to incorporate advertisements for products or services into the display-use video GMV. Hereinafter, products and services are collectively referred to as “commodities.”

The configuration of the game system 1 is not limited to the example shown in FIG. 1. In one example, in the game system 1 shown in FIG. 1, a distribution system, in which a video such as a distribution-use video DMV is distributed to the terminal apparatuses 70, is achieved by a single distribution server 30. However, the distribution system may be achieved by multiple distribution servers 30. In other words, the distribution system may include multiple distribution servers 30. There may be one or more distribution providers for video distribution services to the distribution system. In one example, the distribution system may include (i) one or more distribution servers 30 that are managed by any provider from among multiple providers, and (ii) one or more distribution servers 30 that are managed by other providers.

The number of game apparatuses 10 included in the game system 1 is not limited to one. In one example, the game system 1 may include two or more game apparatuses 10. The advertisement management server 50 may supply, to the distribution server 30, information necessary for the distribution server 30 to distribute banner images. The banner images are still images or videos of advertisements for commodities.

Next, an overview will be given of the display-use video GMV generated by the game apparatus 10 with reference to FIG. 2.

FIG. 2 is a diagram showing an example of an overview of a display-use video GMV generated by the game apparatus 10 shown in FIG. 1.

A display-use video GMV according to this embodiment shows how the computer baseball game is progressed in a virtual space FD, such as a virtual baseball ground. In an example shown in FIG. 2, the display-use video GMV shows that, in the virtual space FD, a pitcher character CR1 is throwing a ball object OB1, and a batter character CR2 is hitting the ball object OB1 thrown by the pitcher character CR1 with a baseball bat object OB2. In an example of the display-use video GMV, spectator characters CR3 watch the baseball game in the virtual space FD.

The progress of the computer baseball game in the virtual space FD is an example of a “state of a virtual space of a computer game.” The state of the virtual space FD may be some or all states relating to a game element in the virtual space FD, or it may be some or all states relating to sound in the virtual space FD. Alternatively, the state of the virtual space FD may be some or all states including: (i) a state relating to a game element in the virtual space FD; and (ii) a state relating to sound in the virtual space FD.

A game element in the virtual space FD may be disposed at any position in the virtual space FD. Here, the game element may be controlled by a program (a processor that executes the program) of the game apparatus 10. Furthermore, the game element may be a character, an object, and an environmental component in the virtual space FD. The environmental component in the virtual space FD may be an element of a virtual baseball ground in the virtual space FD. Examples of the element of the virtual baseball ground include a baseball ground, and a back net thereof.

A state relating to a game element may be a position of a game element in the virtual space FD, or it may be the shape, pattern, or color of the game element. Alternatively, the state relating to the game element may be a direction or a movement speed of the game element in the virtual space FD. Alternatively, the “situation relating to the game element” may be some or all of the position, shape, pattern, color, direction of movement, and speed of movement of the game element in the virtual space FD.

Sound in the virtual space FD may be output or heard at any position in the virtual space FD, or it may be associated with a game element in the virtual space FD, or it may be both of these. The sound may include audio (voice).

In some cases, the display-use video GMV according to this embodiment includes one or more video advertisements AD (an example of an “advertisement”). In this embodiment, video advertisements AD may be still images or moving images relating to commodities for advertisements, which are displayed on game elements in the virtual space FD. Alternatively, the video advertisements AD may be audios relating thereto, which are output from game elements in the virtual space FD.

In the following description, if a video advertisement AD is a still image or a moving image displayed on a game element in the virtual space FD, it is referred to as an “image advertisement ADi.” In FIG. 2, in order to distinguish an image advertisement ADi from others, a dash and an appended number (e.g., 1 or 2) are added at the end of the reference sign thereof. Hereinafter, if a video advertisement AD is an audio in the virtual space FD, it is referred to as an “audio advertisement ADs.”

In FIG. 2, an example will be given in which (i) an image advertisement ADi-1 is a still image displayed on a billboard BDa on a fence BS in a virtual baseball ground, and (ii) an image advertisement ADi-2 is a still image displayed on a billboard BDb on the fence BS therein. Furthermore, in FIG. 2, an example will be given in which an audio advertisement ADs is an audio output from a speaker object OB3 in the virtual baseball ground.

In this embodiment, an assumption will be made in which image advertisements ADi are displayed on the billboards BDa and BDb. However, the position at which an image advertisement ADi is displayed is not limited to the billboards BD (including BDa and BDb). In one example, the image advertisement ADi may be displayed on the uniforms of player characters, such as a pitcher character CR1 and a batter character CR2.

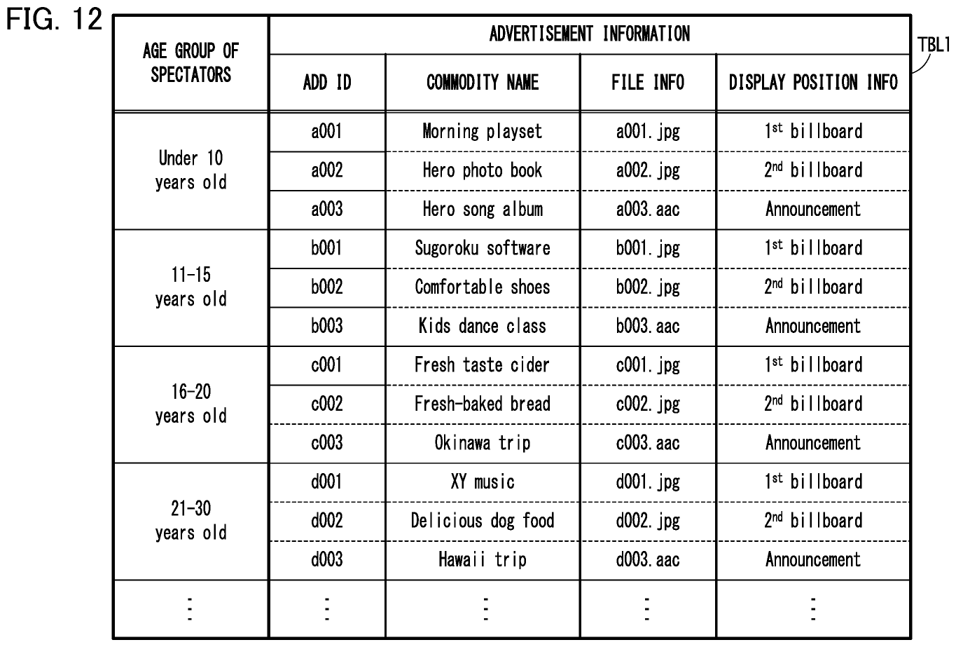

In this embodiment, the image advertisements ADi being displayed on the billboards BDa and BDb, and the audio advertisement ADs being output from the speaker object OB3, and the like, mean that “the video advertisements AD are displayed in the virtual space FD.” Furthermore, in this embodiment, content of each of the video advertisements AD to be displayed in the virtual space FD (e.g., content of video advertisements ADi to be displayed on the billboards BDa or BDb) is determined based on the number of the terminal apparatuses 70 playing distribution-use videos DMV. The method of determining video advertisements AD to be displayed in the virtual space FD will be described later in FIG. 12.

Next, description will be given of an overview of a video distribution screen DS supplied by the distribution server 30 to a terminal apparatus 70-m with reference to FIG. 3.

FIG. 3 is a diagram showing an example overview of a video distribution screen DS supplied by the distribution server 30 to a terminal apparatus 70-m.

In one example, on the video distribution screen DS displayed is a distribution-use video DMV supplied from the distribution server 30. Furthermore, as shown in FIG. 3, on the video distribution screen DS shown are, for example, a play button BTst, a full screen button BTfs, a like button BTgd, a comment entering area CIW, and a comment display area CDW. In one example, during stopping of a play of the distribution-use video DMV displayed on the video distribution screen DS, when the play button BTst is clicked, the distribution-use video DMV is resumed. In one example, when the full screen button BTfs is clicked while the distribution-use video DMV is displayed on the video distribution screen DS, the display area of the distribution-use video DMV is expanded to cover the entire display area 71-m.

In one example, when the like button BTgd is clicked while the distribution-use video DMV is displayed on the video distribution screen DS, information indicative of a click of the like button BTgd is sent from the terminal apparatus 70-m to the distribution server 30.

The like button BTgd is used to express user's positive feelings (e.g., like, enjoyable, and agree) toward the distribution-use video DMV. This user is intended to be the user of the terminal apparatus 70-m who watches the distribution-use video DMV.

In one example, the user of the terminal apparatus 70-m enters, into the terminal apparatus 70-m, a comment on the distribution-use video DMV. In the comment entering area CIW, shown is the comment that has been entered to the terminal apparatus 70-m, but it is not yet posted. In the comment display area CDW, shown are comments on the distribution-use video DMV.

In the comment display area CDW, shown are comments posted by users other than the user of the terminal apparatus 70-m who watches the distribution-use video DMV. The comments on the distribution-use video DMV may be displayed on the display 21 of the display apparatus 20 corresponding to the game apparatus 10. In one example, the game apparatus 10 may control the display 21 such that comments on the distribution-use video DMV are displayed in an area different from the area for showing the display-use video GMV.

The video distribution screen DS is not limited to the example shown in FIG. 3. In one example, some or all of the play button BTst, the full screen button BTfs, the like button BTgd, the comment entering area CIW and the comment display area CDW may not be displayed on the video distribution screen DS. In one example, banner images of advertisements of commodities may be displayed on the video distribution screen DS.

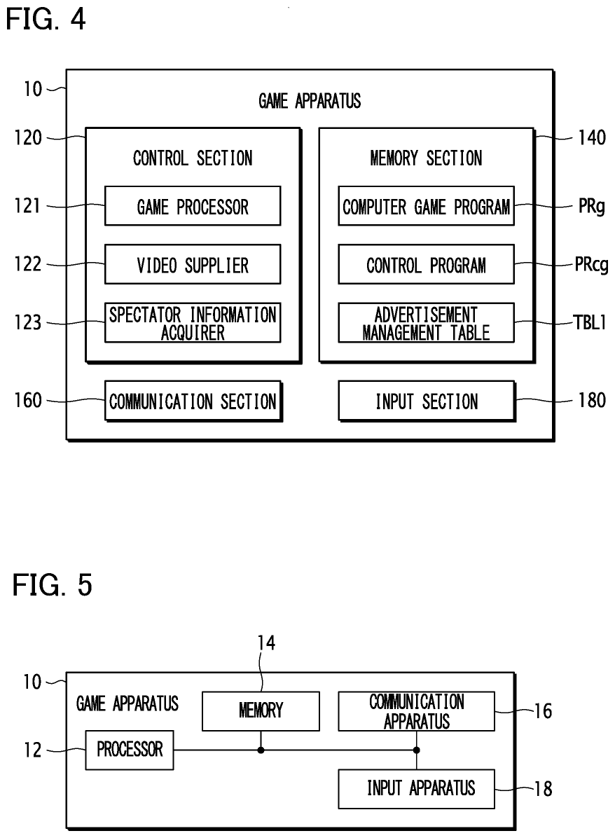

Next, description will be given of functions of the game apparatus 10, the distribution server 30, and the advertisement management server 50 with reference to FIGS. 4 to 9. First, the configuration of the game apparatus 10 will be described with reference to FIGS. 4 and 5.

FIG. 4 is a functional block diagram of an example of the game apparatus 10 shown in FIG. 1.

The game apparatus 10 includes: a control section 120; a memory section 140 that stores therein a computer game program PRg (an example of a “program”), a control program PRcg, and such various information; a communication section 160 that communicates with external apparatuses including the distribution server 30 and the advertisement management server 50; and an input section 180 that receives input made by the user of the game apparatus 10. The computer game program PRg is, for example, an application program for the computer baseball game executed by the game apparatus 10. The control program PRcg is, for example, an application program for controlling each part of the game apparatus 10 by the control section 120. An advertisement management table TBL1 includes information necessary for the game apparatus 10 to incorporate advertisements of commodities into the display-use video GMV. The data structure of the advertisement management table TBL1 will be described later with reference to FIG. 12.

The control section 120 controls each part of the game apparatus 10. Furthermore, the control section 120 controls progress of the computer baseball game executed at the game apparatus 10. In one example, the control section 120 includes a game processor 121 (an example of a “computer game controller”), a video supplier 122 (an example of a “supplier”), and a spectator information acquirer 123 (an example of an “acquirer”).

In one example, the game processor 121 progresses the computer baseball game based on inputs made by the user of the game apparatus 10. The game processor 121 generates, based on a progress result of the computer baseball game, display-use video information GMVinf that is used to play a display-use video GMV. The display-use video MGV indicates a state of the virtual space FD. In one example, the game processor 121 generates progress state information indicative of the state of progressed computer game. Then, the game processor 121 generates, based on the generated progress state information, display-use video information GMVinf that is used to play a display-use video GMV. The display 21 displays the display-use video GMV, based on the display-use video information GMVinf generated by the game processor 121.

In one example, the progress state information is used to manage states of various game elements in the virtual space FD and sound in the virtual space FD, based on the state of the virtual space FD changing as the computer baseball game progress. Specifically, in this embodiment, the progress state information includes some or all of the following: position, shape, posture, orientation, color, pattern, speed of movement, direction of movement of each of the game elements in the virtual space FD, and sound in the virtual space FD.

The display-use video information GMVinf may indicate a display-use still image that is updated per unit period of time (a display-use still image that is updated per unit period of time in real time). Alternatively, it may indicate a set of display-use still images that correspond one-to-one to unit periods of time (a set of display-use still images that have been accumulated over unit periods of time). Alternatively, the display-use video information GMVinf may be obtained by adding information indicative of sound in the virtual space FD to (i) a display-use still image that is updated per unit period of time, or (ii) a set of display-use still images that are updated per unit period of time. The display-use still image may represent the virtual space FD in each unit period of time, and a state of each of the various game elements in each unit period of time.

When distributing a distribution-use video DMV, the video supplier 122 generates, based on the display-use video information GMVinf, distribution-use video information DMVinf that is used to play the distribution-use video DMV, and supplies the generated distribution-use video information DMVinf to the distribution server 30 via the communication section 160. As a result, a distribution-use video DMV based on the distribution-use video information DMVinf is distributed to a terminal apparatus 70-m and to others. It is noted that distribution-use video information DMVinf is generated based on the display-use video information GMVinf, and therefore the distribution-use video DMV based on the distribution-use video information DMVinf corresponds to a distribution video based on the display-use video information GMVinf.

The distribution-use video information DMVinf may indicate a distribution-use still image that is updated per unit period of time (a distribution-use still image that is updated per unit period of time in real time). Alternatively, it may indicate a set of distribution-use still images that correspond one-to-one to unit periods of time (a set of distribution-use still images that have been accumulated over unit periods of time). Alternatively, the distribution-use video information DMVinf may be obtained by adding information on sound in the virtual space FD to (i) a distribution-use still image that is updated per unit period of time, or (ii) a set of distribution-use still images that are updated per unit period of time. Furthermore, as described in FIG. 1, the distribution-use still image may have a lower resolution than the display-use still image, or it may be identical to the display-use still image. The distribution-use video information DMVinf may be generated by a functional block other than the video supplier 122.

The spectator information acquirer 123 acquires, from the distribution server 30, information on one or more terminal apparatuses 70 playing the distribution-use videos DMV.

The terminal apparatuses 70 playing the distribution-use videos DMV are parts of the M terminal apparatuses 70-1 to 70-M, and are spectator apparatuses. Each of the spectator apparatuses receives, from the distribution server 30, the distribution-use video DMV based on the distribution-use video information DMVinf.

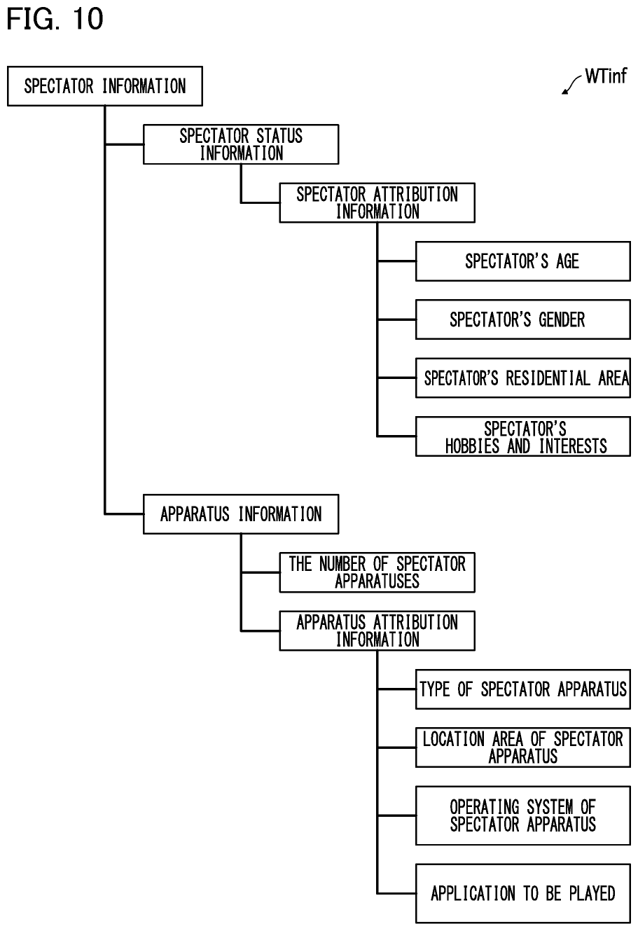

Hereinafter, the terminal apparatuses 70 that receive the distribution-use videos DMV from the distribution server 30, that is, the terminal apparatuses 70 playing the distribution-use video DMV are referred to as “spectator apparatuses.” Furthermore, hereinafter, information on the spectator apparatuses that receive the distribution-use video DMV from the distribution server 30 is referred to as “spectator information WTinf” (see FIG. 10). In one example, the game processor 121 controls content of advertisements to be displayed in the virtual space FD, based on the spectator information WTinf acquired by the spectator information acquirer 123. A detailed description will be given of controlling the content of the advertisements to be displayed in the virtual space FD in FIG. 12.

The configuration of the game apparatus 10 is not limited to the example shown in FIG. 4. In one example, if the display apparatus 20 shown in FIG. 1 is included in the game apparatus 10, the game apparatus 10 may include a display 21 that displays various images, such as a display-use video GMV.

Next, the hardware configuration of the game apparatus 10 will be described with reference to FIG. 5.

FIG. 5 is an example of a hardware configuration of the game apparatus 10 shown in FIG. 4.

The game apparatus 10 includes a processor 12 (an example of a “processor of the game apparatus”) that controls each part of the game apparatus 10, a memory 14 that stores various information, a communication apparatus 16, and an input apparatus 18.

The memory 14 is, for example, a computer-readable recording medium. The memory 14 is a non-transitory storage medium, and functions as the memory section 140. The memory 14 includes one or both of (i) volatile memory, such as Random Access Memory (RAM) as a work area of the processor 12, and (ii) a non-volatile memory, such as an Electrically Erasable Programmable Read-Only Memory (EEPROM) that stores various information, such as the computer game program PRg and the control program PRcg.

The memory 14 may be detachable from the game apparatus 10, specific examples of which include a storage medium, such as a memory card detachable therefrom. The memory 14 may be a memory apparatus (e.g., an online storage) communicatively connected to the game apparatus 10 via the network NW or the like. In other words, the “recording medium” having the computer game program PRg recorded therein may be a storage included in an external apparatus external to the game apparatus 10, or it may be a storage that has the computer game program PRg recorded therein and that is included in a distribution server. The distribution server is external to the game apparatus 10 and distributes the computer game program PRg.

In one example, the processor 12 includes one or more Central Processing Units (CPUs). In one example, the processor 12 executes the control program PRcg stored in the memory 14 and is operated in accordance with the control program PRcg, to function as the control section 120 that controls each part of the game apparatus 10. Furthermore, the processor 12 executes the computer game program PRg stored in the memory 14 and is operated in accordance with the computer game program PRg, to function as the control section 120 that executes the computer baseball game. In one example, the processor 12 that is operated in accordance with the computer game program PRg stored in the memory 14 functions as the control section 120 including the game processor 121, the video supplier 122 and the spectator information acquirer 123.

In one example of the processor 12 including CPUs, some or all of the functions of the control section 120 may be achieved by operation in cooperation with these CPUs in accordance with a program, such as the control program PRcg and the computer game program PRg. In addition to the one or more CPUs, or in place of some or all of the CPUs, the processor 12 may include a Graphics Processing Unit (GPU), a Digital Signal Processor (DSP), a Field Programmable Gate Array (FPGA), or other hardware. A part or all of the control section 120 achieved by the processor 12 may be achieved by hardware, such as a DSP.

The communication apparatus 16 is hardware to communicate with external apparatuses external to the game apparatus 10 via one or both of the wired network and the wireless network, and functions as the communication section 160.

The input apparatus 18 is hardware to receive user inputs made to the game apparatus 10, and functions as the input section 180. In one example, the input apparatus 18 may comprise one or more devices, including some or all of input buttons, a touch panel, a keyboard, a joystick, and a pointing device, such as a mouse.

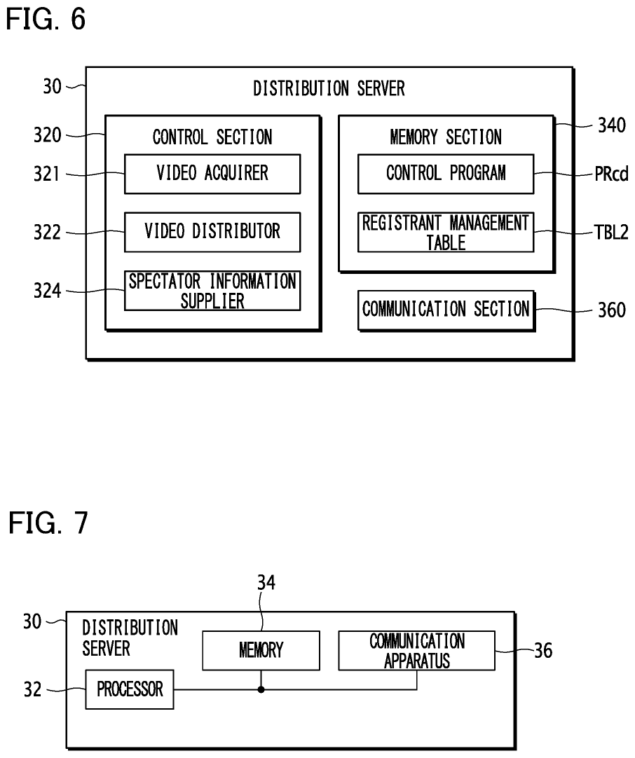

Next, a configuration of the distribution server 30 will be described with reference to FIGS. 6 and 7.

FIG. 6 is a functional block diagram showing an example of the configuration of the distribution server 30 shown in FIG. 1.

The distribution server 30 includes a control section 320 that controls each part of the distribution server 30, a memory section 340 that stores various information, and a communication section 360 that communicates with external apparatuses including the game apparatus 10 and a terminal apparatus 70-m. The control section 320 includes a video acquirer 321 that acquires distribution-use video information DMVinf from the game apparatus 10 via the communication section 360, a video distributor 322, and a spectator information supplier 324 that supplies spectator information WTinf to the game apparatus 10 via the communication section 360.

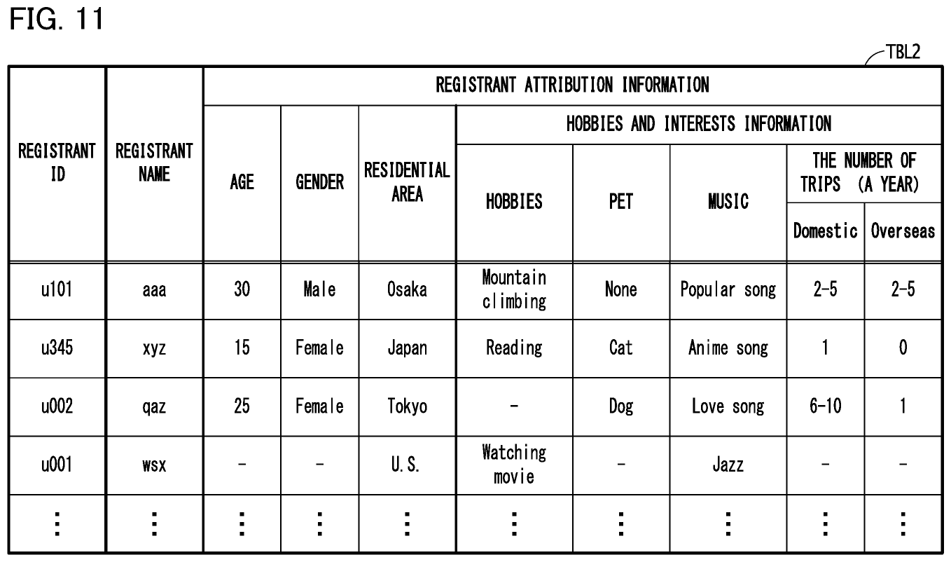

In one example, the video distributor 322 sends, to the terminal apparatus 70-m, information that is used to display a video distribution screen DS on the terminal apparatus 70-m via the communication section 360, to distribute the video distribution screen DS to the terminal apparatus 70-m. Hereinafter, information that is used to show the video distribution screen DS on a terminal apparatus 70 is referred to as “distribution screen information DSinf” (see FIG. 13). In one example, the distribution screen information DSinf may be generated by the video distributor 322, or it may be generated by another functional block different from the video distributor 322. Furthermore, the video distributor 322 sends the distribution-use video information DMVinf to the terminal apparatus 70-m via the communication section 360, to distribute a distribution-use video DMV based on the distribution-use video information DMVinf to the terminal apparatus 70-m. The memory section 340 stores a control program PRcd for controlling each part of the distribution server 30, and various information such as the registrant management table TBL2. In one example, the registrant management table TBL2 includes information that is registered by users for the video distribution service for watching videos distributed from the distribution server 30. The data structure of the registrant management table TBL2 will be described later in FIG. 11.

Next, a hardware configuration of the distribution server 30 will be described with reference to FIG. 7.

FIG. 7 is an example of the hardware configuration of the distribution server 30 shown in FIG. 6.

The distribution server 30 includes a processor 32 that controls each part of the distribution server 30, a memory 34 that stores various information, and a communication apparatus 36 that communicates with external apparatuses external to the distribution server 30.

In one example, the memory 34 functions as a memory section 340, and includes one or both of: (i) a volatile memory, such as a RAM, that acts as a work area of the processor 32; and (ii) a non-volatile memory, such as an EEPROM, for storing various information, such as the control program PRcd. In one example, the processor 32 includes one or more CPUs. The processor 32 executes the control program PRcd stored in the memory 34 and is operated in accordance with the control program PRcd, to function as the control section 320. The communication apparatus 36 is hardware to communicate with external apparatuses external to the distribution server 30, and functions as the communication section 360.

The configuration of the distribution server 30 is not limited to the examples shown in FIGS. 6 and 7. In one example, the distribution server 30 may include an input apparatus that functions as an input section that receives inputs from the administrator.

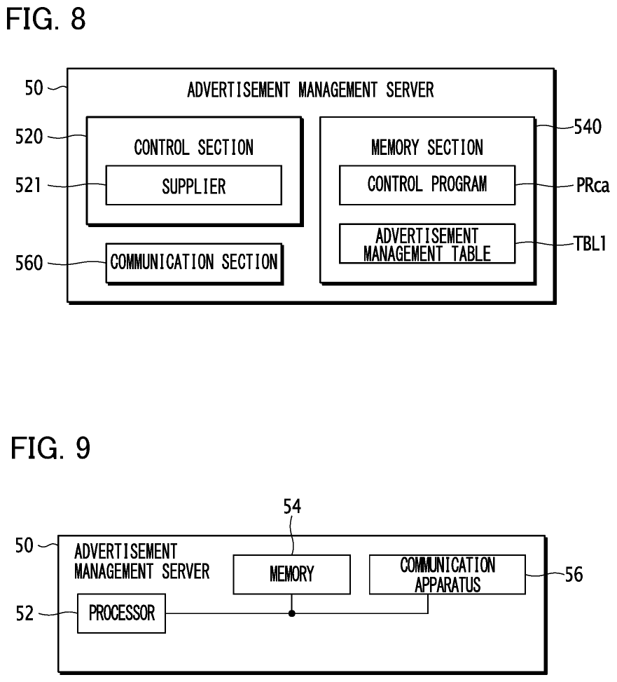

Next, a configuration of the advertisement management server 50 will be described with reference to FIGS. 8 and 9.

FIG. 8 is a functional block diagram showing an example of the configuration of the advertisement management server 50 shown in FIG. 1.

The advertisement management server 50 includes a control section 520 that controls each part of the advertisement management server 50, a memory section 540 that stores various information, and a communication section 560 that communicates with external apparatuses including the game apparatus 10. The control section 520 includes a supplier 521. The memory section 540 stores a control program PRca that is used to control each part of the advertisement management server 50, and various information, such as an advertisement management table TBL1. In one example, the advertisement management table TBL1 stored in the memory section 540 is supplied to the game apparatus 10.

In one example, when receiving a table acquisition request REQtb1 shown in FIG. 13 from the game apparatus 10 via the communication section 560, the supplier 521 sends, to the game apparatus 10 via the communication section 560, the advertisement management table TBL1 stored in the memory section 540. The table acquisition request REQtb1 will be described later. Accordingly, the advertisement management table TBL1 stored in the memory section 140 of the game apparatus 10 shown in FIG. 3 is identical to one sent by the supplier 521 to the game apparatus 10.

Next, a hardware configuration of the advertisement management server 50 will be described with reference to FIG. 9.

FIG. 9 is an example of the hardware configuration of the advertisement management server 50 shown in FIG. 8.

The advertisement management server 50 includes a processor 52 that controls each part of the advertisement management server 50, a memory 54 that stores various information, and a communication apparatus 56 that communicates with external apparatuses external to the advertisement management server 50.

In one example, the memory 54 functions as the memory section 540, and includes one or both of: (i) a volatile memory, such as a RAM, that acts as a work area of the processor 52; and (ii) a non-volatile memory, such as an EEPROM, for storing various information, such as the control program PRca and the advertisement management table TBL1. In one example, the processor 52 includes one or more CPUs. The processor 52 executes the control program PRca stored in the memory 54, and is operated in accordance with the control program PRca, to function as the control section 520. The communication apparatus 56 is hardware to communicate with external apparatuses external to the advertisement management server 50, and functions as the communication section 560.

The configuration of the advertisement management server 50 is not limited to the examples shown in FIGS. 8 and 9. In one example, the advertisement management server 50 may include an input apparatus that functions as an input section that receives inputs by the administrator and others for the advertisement management server 50.

Next, the spectator information WTinf will be described with reference to FIG. 10.

FIG. 10 is a diagram showing an overview of the spectator information WTinf.

As described in FIG. 4, the spectator information WTinf relates to spectator apparatuses that receive distribution-use videos DMV from the distribution server 30. Hereinafter, users of the spectator apparatuses, that is, the users watching the distribution-use videos DMV, are referred to simply as “spectators.” FIG. 10 shows an example of classification of information that corresponds to the spectator information WTinf, and this is not limited to the spectator information WTinf including all of the information shown in FIG. 10.

In one example, the spectator information WTinf may be spectator status information on the spectators, or it may be apparatus information on the spectator apparatuses, or it may be information including both of these. In one example, the spectator status information may be spectator attribution information (an example of “user attribution information”) indicative of attributions of each of the spectators (an example of an “attribution of a user”). The spectator attribution information may be information associated with each spectator. The information associated with each spectator may be item information that is the same for each spectator, and the item information may indicate some or all of age, gender, residential area, hobbies and interests of each of the spectators. The information indicating age of each of the spectators also applies to age groups of the spectators.

In one example, the apparatus information may be the number of spectator apparatuses, or it may be apparatus attribution information indicative of attributions of each of the spectator apparatuses, or it may include both of these. In one example, the apparatus attribution information may indicate some or all of the following: a type, a location area, and an operating system (e.g., iOS (registered trademark) and Android (registered trademark)) of each of the spectator apparatuses; and an application that is used to play distribution-use video DMV. The type of each of the spectator apparatuses may be indicated by whether each is a personal computer, a smartphone, or other device, or it may be indicated by the model thereof. The location area of each of the spectator apparatuses may be indicated by an Internet Protocol (IP) address of each spectator apparatus.

The spectator information WTinf is not limited to the example described above. In one example, the apparatus information may include response information based on user inputs made to the spectator apparatuses. In one example, the response information may be rating information on ratings of a distribution-use video DMV that are given by spectators, or it may be comment information on comments posted by the spectators on the distribution-use video DMV, or it may include both the rating information and the comment information. In one example, the rating information may indicate the number of spectators who gave a favorable rating to the distribution-use video DMV. Specifically, the rating information may indicate the number of users who clicked the like button BTgd shown in FIG. 3, or it may indicate the number of times the like button BTgd has was clicked. In one example, the comment information may indicate the number of comments posted on the distribution-use video DMV.

In one example, if distribution-use video DMV is watchable for users who are not registered for the video distribution service, the spectator status information may include the number of spectators registered for the video distribution service (hereinafter, the “number of registered spectators”) in addition to, or instead of the spectator attribution information. In one example, if a ratio of the number of registered spectators to the number of spectator apparatuses is a predetermined ratio or fewer, the location area of each spectator apparatus may be used in preference to the residential area of each spectator, to predict the region or country where the greatest number spectators live.

In this embodiment, an assumption will be made in which the spectator information WTinf includes the age of each spectator. Next, description of the registrant management table TBL2 stored in the memory section 340 of the distribution server 30 with reference to FIG. 11.

FIG. 11 is an example of a data structure of the registrant management table TBL2.

The registrant management table TBL2 includes records corresponding one-to-one to users who have registered for the video distribution service for watching videos distributed by the distribution server 30. Hereinafter, users who have registered for the video distribution service are referred to as “registered users.

In one example, each record in the registrant management table TBL2 includes a registrant ID, a registrant name, and registrant attribution information indicative of the attributions of the registrant. The registrant ID identifies one registrant among the registrants who have registered for the video distribution service. The information indicative of registrant names is used to distinguish each registrant from the other registrants. The registrant attribution information may be obtained from the user (registrant) when the user has registered for the video distribution service, or after the user registration. The dash (“-”) shown in FIG. 11 indicates that nothing has been obtained from the registrant.

In this embodiment, in one example, the registrant attribution information includes age, gender, residential area of the registrant, and hobbies and interests information. The hobbies and interests information indicates hobbies and interests of the registrant. In the example of the registrant management table TBL2 shown in FIG. 11, the hobbies and interests information includes the registrant's pets, the registrant's favorite music genres, and the number of trips the registrant has taken in a year.

In one example, some or all of the items (age, gender, etc.) included in the registrant attribution information is sent as the spectator information WTinf from the distribution server 30 to the game apparatus 10. The registrant attribution information corresponds to the registrant (spectator) who watches the distribution-use video DMV. In this embodiment, the age of the registrant corresponds to information indicative of the age thereof shown in FIG. 10. The gender of the registrant corresponds to information indicative of the gender thereof shown in FIG. 10. The residential area of the registrant corresponds to information indicative of the residential area thereof shown in FIG. 10. The hobbies and interests information corresponds to hobbies and interests information of each spectator shown in FIG. 10.

The data structure of the registrant management table TBL2 is not limited to the example shown in FIG. 11. In one example, the hobbies and interests information may include one or both of the registrant's Internet browsing history and Internet service usage history. In one example, the hobbies and interests information may include results of analysis of the registrant's interests based on one or both of the browsing history and the usage history.

Next, description will be given of the advertisement management table TBL1 stored in the memory section 540 of the advertisement management server 50 with reference to FIG. 12.

FIG. 12 is an example of the data structure of the advertisement management table TBL1.

In the advertisement management table TBL1 shown in FIG. 12, the ages of the spectators are divided into gropes. Advertisement information, which includes an advertisement ID, a commodity name, file information, and display position information, is managed for each of the age groups. In one example, the age of the spectators may be divided in accordance with the age group which targets users of the advertisement (hereinafter, a target audience of the advertisement). The age of the target audience of the advertisement may be obtained from the advertiser.

The advertisement ID identifies one from among multiple video advertisements AD. The commodity name is one that is given to a video advertisement AD that is targeted and corresponds to the advertisement ID.

If the video advertisement AD corresponding to an advertisement ID is an image advertisement ADi, the file information indicates a still image file or a video file that is used to display the image advertisement ADi corresponding to the advertisement ID. If the video advertisement AD corresponding to the advertisement ID is an audio advertisement ADs, the file information indicates an audio file that is used to play the audio advertisement ADs corresponding to the advertisement ID. Hereinafter, a still image file or a video file that is used to display an image advertisements ADi, and an audio file that is used to play an audio advertisement ADs may be collectively referred to as an “advertisement file.”

In one example, when acquiring the advertisement management table TBL1 from the advertisement management server 50, the game apparatus 10 may acquire, from the advertisement management server 50, an advertisement file that is registered in the advertisement management table TBL1 to be acquired. Alternatively, when determining a video advertisement AD to be display in the virtual space FD, the game apparatus 10 may acquire, from the advertisement management server 50, an advertisement file for the determined video advertisement AD.

The display position information indicates a position in the virtual space FD at which the video advertisement AD associated with the advertisement ID is displayed. If the video advertisement AD associated with the advertisement ID is an image advertisement ADi, examples of a position in the virtual space FD at which the video advertisement AD is displayed include positions of billboards. In one example, a “first billboard” shown in FIG. 12 corresponds to the billboard BDa shown in FIG. 2, and a “second billboard” corresponds to the billboard BDb shown in FIG. 2.

If the video advertisement AD associated with the advertisement ID is an audio advertisement ADs, examples of a position in the virtual space FD at which the video advertisement AD is displayed include announcements. In one example, the announcements shown in FIG. 12 mean that content of an audio advertisement ADs is output as an audio from the speaker object OB3 shown in FIG. 2. In FIG. 2, to clarify the description, an example has been described in which the speaker object OB3 is displayed on the screen for a display-use video GMV. However, even if the speaker object OB3 is not displayed on the screen of the display-use video GMV, audio for the audio advertisement ADs may be output.

Hereinafter, the position in the virtual space FD at which a video advertisement AD is displayed is referred to as a “display position.”

The data structure of the advertisement management table TBL1 is not limited to the example shown in FIG. 12. In one example, a field for the file information may include a first subfield for a still image file or a video file, and a second subfield for an audio file.

Next, an example will be described of a method of determining a video advertisement AD to be displayed in the virtual space FD using the advertisement management table TBL1. Determining a video advertisement AD to be displayed in the virtual space FD corresponds to determining content of the advertisement to be displayed in the virtual space FD.

In one example, the game processor 121 collects the ages of the spectators, based on the spectator information WTinf acquired by the spectator information acquirer 123. The game processor 121 then identifies, based on the result of the collected ages of the spectators, an age group to which the greatest number of spectators who watch the distribution-use video DMV belong, from among the age groups of spectators included in the advertisement management table TBL1. Furthermore, from among the age groups of spectators included in the advertisement management table TBL1, the game processor 121 determines to display, in the virtual space FD, a video advertisement AD for the age group to which the greatest number of spectators belong.

In one example, when the age group to which the greatest number of spectators belong is “16 to 20-year-olds,” the game processor 121 determines that the following (i) to (iii) are video advertisements AD to be displayed in the virtual space FD: (i) an image advertisement ADi of “Fresh Taste Cider;” (ii) an image advertisement ADi of “Fresh-baked Bread;” and (iii) an audio advertisement ADs of “Okinawa Trip.” As a result, the image advertisement ADi of “Fresh Taste Cider” is displayed on the billboard BDa shown in FIG. 2. The image advertisement ADi of “Fresh-baked Bread” is displayed on the billboard BDb. The audio advertisement ADs of “Okinawa Trip” is played from the speaker object OB3. Thus, when the age group to which the greatest number of spectators belong is “16 to 20-year-olds,” video advertisements AD that target users in the age group “16 to 20-year-olds” are displayed in the virtual space FD.

Furthermore, in one example, when the age group to which the greatest number of spectators belong is “21 to 30-year-olds,” the game processor 121 determines that the following (i) to (iii) are video advertisements AD to be displayed in the virtual space FD: (i) an image advertisement ADi “XY Music;” (ii) an image advertisement ADi “Delicious Dog Food;” and (iii) an audio advertisement ADs “Hawaii Trip.” Thus, the game processor 121 determines content of advertisements to be displayed in the virtual space FD, based on the spectator information WTinf acquired by the spectator information acquirer 123.

The game processor 121 may determine to display the following (i) and (ii) in the virtual space FD: (i) a video advertisement AD for the age group to which the greatest number of spectators belong (hereinafter, a “first majority age group”); and (ii) a video advertisement AD for the age group to which the second greatest number of spectators belong (hereinafter, a “second majority age group”).

In one example, if the difference between the number of people in the first majority age group and the number of people in the second majority age group is a predetermined value or fewer, the game processor 121 may determine to display the following (i) and (ii) in the virtual space FD: (i) a video advertisement AD for the first majority age group, and (ii) a video advertisement AD for the second majority age group. Alternatively, instead of the difference described above, a ratio of the number of people in the first majority age group to the number of people in the second majority age group is used to determine video advertisements AD to be displayed.

Next, an overview of procedures for the game system 1 will be described with reference to FIG. 13.

FIG. 13 is a sequence chart of example procedures for the game system 1 shown in FIG. 1.

In FIG. 13, the terminal apparatuses 70-1 and 70-2 are shown from among the M terminal apparatuses 70 to clarify the drawing. However, the terminal apparatuses 70 playing distribution-use videos DMV are not limited to the terminal apparatuses 70-1 and 70-2. Hereinafter, an example of the procedures for the game system 1 shown in FIG. 13 is referred to as “system procedure example.”

First, the control section 120 of the game apparatus 10 controls each part of the game apparatus 10 to send, to the advertisement management server 50, a table acquisition request REQtb1 that is used to acquire the advertisement management table TBL1 (S100).

When the advertisement management server 50 receives the table acquisition request REQtb1, the control section 520 thereof controls each part of the advertisement management server 50 to send the advertisement management table TBL1 to the game apparatus 10 that has sent the table acquisition request REQtb1 (S500). The control section 120 of the game apparatus 10 receives the advertisement management table TBL1 from the advertisement management server 50 via the communication section 160 (S102). The advertisement management table TBL1 is a response to the table acquisition request REQtb1.

As long as the game apparatus 10 acquires the advertisement management table TBL1 before the start of step S126 (determining a content of an advertisement), the table acquisition request REQtb1 may be sent to the advertisement management server 50 after the start of the computer baseball game. Description of step S126 will be given later.

The control section 120 of the game apparatus 10 controls each part of the game apparatus 10 to send a distribution start request REQst to the distribution server 30 (S104). The distribution start request REQst indicates that the game apparatus 10 will start to supply a distribution-use video DMV to the distribution server 30.

When the distribution server 30 receives the distribution start request REQst, the control section 320 thereof controls each part of the distribution server 30 to send a permission response ACKst to the game apparatus 10 (S300). The permission response ACKst is a response to the distribution start request REQst. Thereafter, the control section 120 of the game apparatus 10 acquires, via the communication section 160, the permission response ACKst that is sent from the distribution server 30 and is a response to the distribution start request REQst (S106).

Thereafter, the control section 120 of the game apparatus 10 starts the computer baseball game (S108). The control section 120 of the game apparatus 10 may start the computer baseball game before sending the distribution start request REQst to the distribution server 30. After the start of the computer baseball game, the control section 120 of the game apparatus 10 controls each part of the game apparatus 10 to send the distribution-use video information DMVinf to the distribution server 30 (S118). As a result, the distribution server 30 receives a supply of the distribution-use video DMV based on the video information DMVinf.

In the system procedure example, the distribution period starts at the timing of step S118. In other words, in the system procedure example, the timing of step S118 corresponds to a distribution start time t0. In the example shown in FIG. 13, during the distribution period, an assumption will be made in which each of the terminal apparatuses 70-1 and 70-2 sends a video distribution screen request REQds to the distribution server 30 (S700).

In one example, the terminal apparatus 70-1 sends a video distribution screen request REQds to the distribution server 30 (S700-1). When the distribution server 30 receives the video distribution screen request REQds, the control section 320 thereof controls each part of the distribution server 30 to send distribution screen information DSinf to the terminal apparatus 70-1 (S302a). As described in FIG. 6, the distribution screen information DSinf is used to show a video distribution screen DS on the terminal apparatus 70.

Thereafter, while the video distribution screen DS is shown in the display 71-1 of the terminal apparatus 70, when the play button BTst is clicked, the terminal apparatus 70-1 sends a video distribution request REQmv to the distribution server 30 (S702-1). In one example, the video distribution request REQmv indicates a request for distributing a distribution-use video DMV.

In the system procedure example, an example will be assumed in which step S702-1 is executed at a timing after time t0, but before time t1. In the system procedure example, time t1 indicates time at which the game apparatus 10 sends a spectator information acquisition request REQwt to the distribution server 30. This request REQwt will be described later.

When the distribution server 30 receives the video distribution request REQmv, the control section 320 thereof controls each part of the distribution server 30 to send the distribution-use video information DMVinf to the terminal apparatus 70-1 (S304a). Although details are not shown in FIG. 13, the terminal apparatus 70-1 plays the distribution-use video DMV, based on the distribution-use video information DMVinf received from the distribution server 30.

In one example, the terminal apparatus 70-2 sends a video distribution screen request REQds to the distribution server 30 (S700-2). When the distribution server 30 receives the video distribution screen request REQds, the control section 320 thereof controls each part of the distribution server 30 to send a distribution screen information DSinf to the terminal apparatus 70-2 (S302b).

Thereafter, when the video distribution screen DS is displayed on the display 71-2 of the terminal apparatus 70-2, when the play button BTst is clicked, the terminal apparatus 70-2 sends a video distribution request REQmv to the distribution server 30 (S702-2).

When the distribution server 30 receives the video distribution request REQmv, the control section 320 thereof controls each part of the distribution server 30 to send distribution-use video information DMVinf to the terminal apparatuses 70-1 and 70-2 (S304b). Before receiving the video distribution request REQmv from the terminal apparatus 70-2, the distribution server 30 has started distributing the distribution-use video DMV to the terminal apparatus 70-1. For this reason, at step S304b, the distribution-use video information DMVinf is sent to both terminal apparatuses 70-1 and 70-2.

At time t1 after a predetermined time Ta has elapsed from the distribution start time t0, the control section 120 of the game apparatus 10 controls each part of the game apparatus 10 to send, to the distribution server 30, a spectator information acquisition request REQwt that is used to acquire spectator information WTinf (S122). When the distribution server 30 receives the spectator information acquisition request REQwt, the control section 320 thereof controls the distribution server 30 to send the spectator information WTinf to the game apparatus 10 (S306). The control section 120 of the game apparatus 10 acquires the spectator information WTinf via the communication section 160. The spectator information WTinf relates to the terminal apparatus 70 receiving the distribution-use video DMV from the distribution server 30 (S124).

The control section 120 of the game apparatus 10 determines the content of each of the advertisements to be displayed in the virtual space FD, based on (i) the spectator information WTinf acquired from the distribution server 30 at step S124, and (ii) the advertisement management table TBL1 acquired from the advertisement management server 50 at step S102 (S126). In one example, as described in FIG. 12, the control section 120 of the game apparatus 10 determines to display, in the virtual space FD, a video advertisement AD that targets the age group to which the greatest number of spectators belong.

In one example, after step S126 (determining content of an advertisement), the control section 120 of the game apparatus 10 incorporates the video advertisements AD determined at step S126 into the virtual space FD. Thus, the video advertisements AD are set, as textures, to objects (e.g., the billboards BD) in the virtual space FD. Then, the control section 120 of the game apparatus 10 generates display-use video information GMVinf that is used to play a display-use video GMV. The display-use video GMV indicates a state of the virtual space FD in which the video advertisements AD are incorporated. The control section 120 generates distribution-use video information DMVinf based on the generated display-use video information GMVinf. The distribution-use video information DMVinf generated based on the display-use video information GMVinf is sent from the game apparatus 10 to the distribution server 30 (S138).

In other words, the control section 120 of the game apparatus 10 determines the content of the advertisements, and then controls each part of the game apparatus 10 to send the distribution-use video information DMVinf to the distribution server 30 (S138). As a result, the distribution-use video DMV based on the distribution-use video information DMVinf is supplied to the distribution server 30.

The control section 320 of the distribution server 30 controls each part of the distribution server 30 to send the distribution-use video information DMVinf to the terminal apparatuses 70-1 and 70-2 (S304c). Each of the terminal apparatuses 70 plays a distribution-use video DMV, based on the distribution-use video information DMVinf received from the game apparatus 10 via the distribution server 30. For this reason, video advertisements AD are incorporated into the virtual space FD shown by the distribution-use video DMV (i.e., the virtual space FD played by each of the terminal apparatuses 70).

As described above, in the system procedure example, content of each of advertisements to be displayed in the virtual space FD is determined after time t1. In other words, content of each of the advertisements to be displayed in the virtual space FD is not determined before time t1 (i.e., a period of time from the distribution start time t0 until the predetermined time Ta elapses). Accordingly, before content of each of the advertisements is determined (e.g., before time t1), video advertisements AD may not be displayed in the virtual space FD.

The procedures for the game system 1 are not limited to the example shown in FIG. 13. In one example, step S122 (sending a spectator information acquisition request REQwt to the distribution server 30) may be omitted. If step S122 is omitted, the distribution server 30 may repeatedly send spectator information WTinf to the game apparatus 10 at intervals. In this case, the control section 120 of the game apparatus 10 may determine the content of each of the advertisements, based on the spectator information WTinf which is first received by the game apparatus 10 from the distribution server 30 after time t1. Alternatively, the control section 120 of the game apparatus 10 may determine the content of each of the advertisements based on the spectator information WTinf which was last received by the game apparatus 10 from the distribution server 30 before time t1.

If step S122 is omitted, the distribution server 30 may send the spectator information WTinf to the game apparatus 10 at time t1, which is after the predetermined time Ta has elapsed from the distribution start time t0.

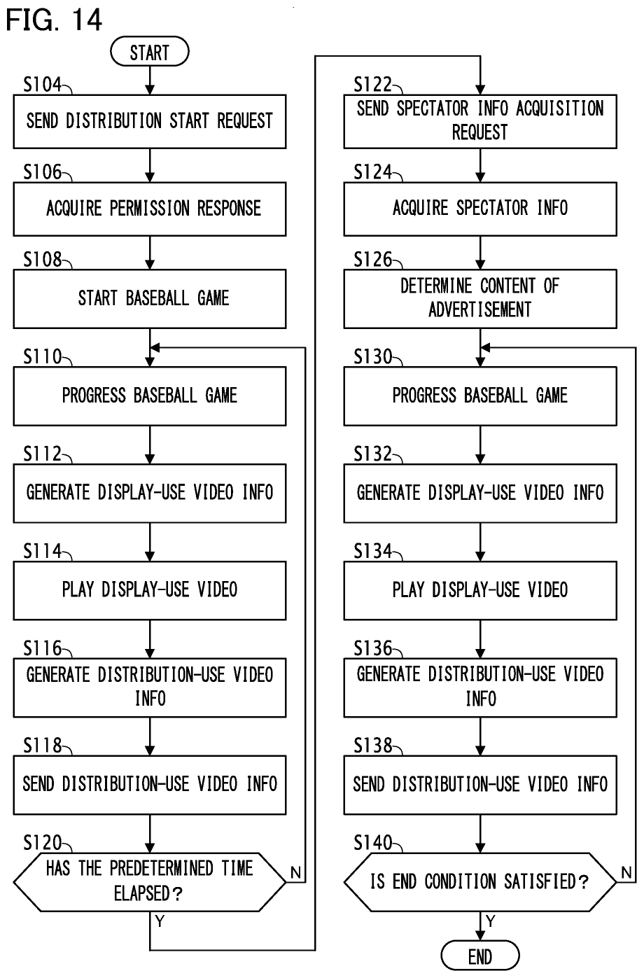

FIG. 14 is a flowchart showing an example of procedures for the game apparatus 10 shown in FIG. 1.

In FIG. 14, an example is shown of procedures for the game apparatus 10 after a series of steps S100 and S102 shown in FIG. 13 is executed (sending a table acquisition request REQtb1 and acquiring the advertisement management table TBL1). Step S104 shown in FIG. 14 is executed after the series of steps S100 and S102 shown in FIG. 13. Detailed description is omitted for procedures similar to those described in FIG. 13.

At step S104, the game processor 121 sends a distribution start request REQst to the distribution server 30. At step S106, the game processor 121 acquires a permission response ACKst that is sent from the distribution server 30 and is a response to the distribution start request REQst. Thereafter, at step S108, the game processor 121 starts the computer baseball game.

In one example, at step S110, the game processor 121 progresses the computer baseball game, based on an input made to the input section 180 of the game apparatus 10. At step S110, the game processor 121 may generate progress state information indicative of the state of the computer game progressed based on an input made to the input section 180 of the game apparatus 10.

Next, at step S112, the game processor 121 generates display-use video information GMVinf. The display-use video information GMVinf is used to play a display-use video GMV indicative of the state of the computer game progressed at step S110. In one example, the game processor 121 generates distribution-use video information GMVinf that is used to play a display-use video GMV, based on the progress state information indicative of the state of the computer game progressed at step S110. In the procedures shown in FIG. 14, video advertisements AD based on the advertisement management table TBL1 are not incorporated into the display-use video information GMVinf generated at step S112.

Next, at step S114, the game processor 121 plays the display-use video GMV, based on the display-use video information GMVinf generated at step S110. As a result, the display-use video GMV is displayed on the display 21.

Next, at step S116, the video supplier 122 generates distribution-use video information DMVinf that is used to play a distribution-use video DMV, based on the display-use video information GMVinf generated at step S112. The video advertisements AD based on the advertisement management table TBL1 are not incorporated into the distribution-use video information DMVinf generated based on the display-use video information GMVinf generated at step S112.

Next, at step S118, the video supplier 122 sends, to the distribution server 30, the distribution-use video information DMVinf generated at step S116. The distribution-use video DMV based on the distribution-use video information DMVinf is supplied to the distribution server 30, and a distribution period starts.

Next, at step S120, the spectator information acquirer 123 determines whether the predetermined time Ta has elapsed from the distribution start time t0. When the result of the determination at step S120 is negative, the spectator information acquirer 123 returns the process to step S110. When the result of the determination at step S120 is positive, the spectator information acquirer 123 moves the process to step S122.

At step S122, the spectator information acquirer 123 sends a spectator information acquisition request REQwt to the distribution server 30. At step S124, the spectator information acquirer 123 acquires the spectator information WTinf that is sent from the distribution server 30 and is a response to the spectator information acquisition request REQwt.

Next, at step S126, the game processor 121 determines content of each of the advertisements to be displayed in the virtual space FD, based on (i) the advertisement management table TBL1 and (ii) the spectator information WTinf acquired from the distribution server 30 at step S124. In one example, the game processor 121 identifies, based on the spectator information WTinf, the age group to which the greatest number of spectators belong, from among the age groups of spectators included in the advertisement management table TBL1. From among video advertisements AD managed in the advertisement management table TBL1, the game processor 121 then determines to display, in the virtual space FD, a video advertisement AD for the age group identified based on the spectator information WTinf (the age group to which the greatest number of spectators belong).

Then, the game processor 121 executes a series of steps S130 to S138. The series of steps S130 to S138 is identical to that of steps S110 to S118, except that video advertisements AD determined at step S126 are incorporated into the virtual space FD.

In one example, step S130 is identical to step S110. Furthermore, step S132 is identical to step S112, and step S134 is identical to step S114. However, the display-use video information GMVinf generated at step S132 differs from that generated at step S112 in that the video advertisements AD based on the advertisement management table TBL1 are incorporated into the virtual space FD. Accordingly, the video advertisements AD based on the advertisement management table TBL1 are incorporated into the virtual space FD shown by the display-use video GMV played at step S134.

Step S136 is identical to step S116, and step S138 is identical to step S118. However, the distribution-use video information DMVinf generated at step S136 differs from that generated at step S116 in that the video advertisements AD based on the advertisement management table TBL1 are incorporated into the virtual space FD. Accordingly, the video advertisements AD based on the advertisement management table TBL1 are incorporated into the virtual space FD shown by the distribution-use video DMV. This distribution-use video DMV is based on the distribution-use video information DMVinf sent to the distribution server 30 at step S138. After step S138, the video supplier 122 moves the process to step S140.

At step S140, the game processor 121 determines whether a predetermined end condition is satisfied, for example, the computer baseball game has ended. When the result of the determination at step S140 is negative, the game processor 121 returns the process to step S130. When the result of the determination at step S140 is positive, the game processor 121 ends the processes shown in FIG. 14.

The procedures of the game apparatus 10 are not limited to the example shown in FIG. 14. In one example, steps S104 and S106 may be executed by a functional block other than the game processor 121, such as the video supplier 122. In one example, step S120 (determining whether the predetermined time Ta has elapsed from the distribution start time t0) may be executed by a functional block different from the spectator information acquirer 123, such as the game processor 121. In addition, step S122 (sending a spectator information acquisition request REQwt to the distribution server 30) may be omitted.

In one example, step S116 (sending distribution-use video information DMVinf) may be executed before step S114 (playing a display-use video GMV), or it may be executed in parallel with step S114. Similarly, step S136 may be executed before step S134, or it may be executed in parallel with step S134. Furthermore, in one example, a series of steps S116 and S118 may be executed before step S114 (playing a display-use video GMV), or it may be executed in parallel with step S114. Similarly, in one example, a series of steps S136 and S138 may be executed before step S134 (playing a display-use video GMV), or it may be executed in parallel with step S134.

In the foregoing embodiment, the game processor 121 progresses the computer baseball game, and generates, based on the progress result of the computer baseball game, display-use video information GMVinf that is used to play a display-use video GMV. The display-use video GMV indicates a state of the virtual space FD of the computer baseball game. The video supplier 122 supplies the distribution-use video DMV based on the distribution-use video information DMVinf to the distribution server 30. The distribution-use video information DMVinf is generated based on the display-use video information GMVinf. Furthermore, the spectator information acquirer 123 acquires spectator information WTinf from the distribution server 30. The spectator information WTinf relates to one or more terminal apparatuses 70 (spectator apparatuses), each of which is a part of the terminal apparatuses and receives a distribution-use video DMV from the distribution server 30. The game processor 121 determines video advertisements AD to be displayed in the virtual space FD, based on the spectator information WTinf acquired by the spectator information acquirer 123.

Thus, in this embodiment, a video advertisement AD to be displayed in the virtual space FD is determined based on the spectator information WTinf. The spectator information WTinf relates to the terminal apparatuses 70 which receive distribution-use videos DMV from the distribution server 30. The terminal apparatuses 70 that receive the distribution-use videos DMV from the distribution server 30 correspond to terminal apparatuses 70 that play the distribution-use videos DMV. For this reason, determining a video advertisement AD to be displayed in the virtual space FD based on the spectator information WTinf is the same as determining a video advertisement AD to be displayed in the virtual space FD by looking at the presence of spectators of the computer baseball game. Accordingly, in this embodiment, content of an advertisement in the virtual space FD is controlled by looking not only at the users playing the computer baseball game, but also at the spectators watching the video thereof.

Specifically, in one example, if the spectator information WTinf indicates an age group of spectators watching the distribution-use videos DMV, the game processor 121 determines, based on the age group of the spectators, a video advertisement AD to be displayed in the virtual space FD.

Thus, in this embodiment, a video advertisement AD to be displayed in the virtual space FD is determined by looking at age groups of spectators of the computer baseball game. In this embodiment, the age groups of the spectators watching the computer baseball game in real time can be known based on the spectator information WTinf. Accordingly, a video advertisement AD to be displayed in the virtual space FD is determined based on the age groups thereof.

### 2. Modifications

The mode described above may be variously modified. Specific modified modes will be exemplified below. Two or more modes freely selected from among the following examples may be appropriately combined so long as they do not conflict. In the modifications exemplified below, elements having operations and functions equivalent to those of the embodiment are also assigned symbols referred to in the above description, and detailed descriptions of the elements are omitted as appropriate.

### Modification 1

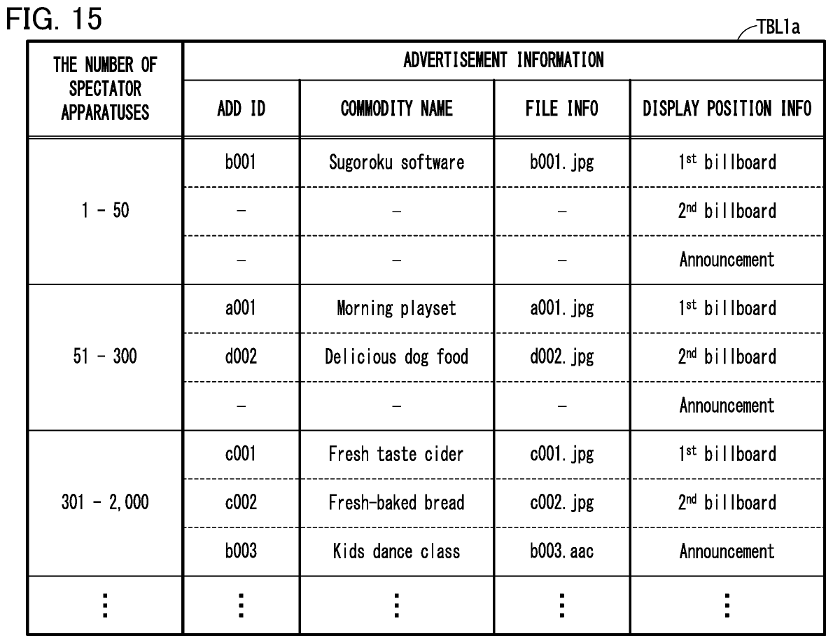

In the foregoing embodiment, an example has been described in which a video advertisement AD to be displayed in the virtual space FD is determined in accordance with the age groups of spectators. However, the present disclosure is not limited to such an aspect. In one example, if the number of spectator apparatuses is included in the spectator information WTinf, the game processor 121 may determine a video advertisement AD to be displayed in the virtual space FD, based on the number of the spectator apparatuses. In this case, as shown in FIG. 15, advertisement information, which includes an advertisement ID, a commodity name, file information, and display position information, is managed using classifications based on the number of spectator apparatuses.

FIG. 15 is an example of a data structure of an advertisement management table TBL1a according to Modification 1.

In the advertisement management table TBL1a shown in FIG. 15, for example, the number of spectator apparatuses is divided into groups. The advertisement information, which includes an advertisement ID, a commodity name, file information, and display position information, is managed for each of the groups. In one example, the number of spectator apparatuses may be classified based on advertising fees for displaying advertisements in the virtual space FD. The dash (“-”) shown in FIG. 15 indicates that a video advertisement to be displayed in the virtual space FD AD is not identified.

The advertising information is identical to that described in FIG. 12. In one example, the advertisement information includes an advertisement ID, a commodity name, file information, and display position information, description of which will be omitted since these have been described for FIG. 12.

In one example, the spectator information WTinf is acquired by the spectator information acquirer 123. The game processor 121 identifies the group to which the number of spectator apparatuses obtained from the spectator information WTinf belongs from among the groups of the number of spectator apparatuses included in the advertisement management table TBL1a. The game processor 121 then determines to display, in the virtual space FD, a video advertisement AD corresponding to the identified group.

In one example, if the number of spectator apparatuses is “12,” the game processor 121 determines that an image advertisement ADi of “Sugoroku Software” is a video advertisement AD to be displayed in the virtual space FD. In this case, the image advertisement ADi of “Sugoroku Software” is displayed on the billboard BDa shown in FIG. 2. No image advertisement ADi may be displayed on the billboard BDb, or a predetermined image advertisement ADi may be displayed thereon. The predetermined image advertisement ADi may be an image advertisement (e.g., “Sugoroku Software”) ADi displayed on the billboard BDa. No audio advertisement ADs may be played from the speaker object OB3, or a predetermined audio advertisement ADs may be played therefrom.

In one example, if the number of spectator apparatuses is “234”, the game processor 121 determines that image advertisements ADi of “Morning Playset,” and “Tasty Dog Food” are video advertisements AD to be displayed in the virtual space FD. In this case, the image advertisements ADi “Morning Playset” is displayed on the billboard BDa shown in FIG. 2. The image advertisement ADi “Tasty Dog Food” is displayed on the billboard BDb. No audio advertisement ADs may be played from the speaker object OB3, or a predetermined audio advertisement ADs may be played therefrom.

In one example, if the number of spectator apparatuses is “345”, the game processor 121 determines that the following (i) to (iii) are video advertisements AD to be displayed in the virtual space FD: (i) an image advertisement ADi of “Fresh Taste Cider,” (ii) an image advertisement ADi of “Fresh-baked Bread;” and (iii) an audio advertisement ADs of “Okinawa Trip.” In this case, the image advertisement ADi of “Fresh Taste Cider” is displayed on the billboard BDa shown in FIG. 2. The image advertisement ADi of “Fresh-baked Bread” is displayed on the billboard BDb. The audio advertisement ADS of “Okinawa Trip” is played from the speaker object OB3. Thus, the game processor 121 displays the video advertisements AD in the virtual space FD in accordance with the number of spectator apparatuses.

The game processor 121 may determine video advertisements AD to be displayed in the virtual space FD, based on information other than the number of spectator apparatuses. In example, if response information based on user input is included in the spectator information WTinf, the game processor 121 may determine, based on the response information, video advertisements AD to be displayed in the virtual space FD. Specifically, in one example, if the response information indicates the number of spectators who have clicked the like button BTgd shown in FIG. 3, the “number of spectators who have clicked the like button BTgd” may be used instead of the “number of spectator apparatuses.”

In one example, if the spectator information WTinf includes the hobbies and interests of spectators, the game processor 121 may determine video advertisements AD to be displayed in the virtual space FD, based on the hobbies and interests of the spectators. In this case, in the advertisement management table TBL1a, advertisement information, which includes an advertisement ID, a commodity name, file information, and display position information, may be managed for classification based on the hobbies and interests of the spectators. Specifically, in one example, the advertisement information may be managed separately for the following (i) to (v): (i) spectators who have no pets, (ii) spectators who have cats, (iii) spectators who have dogs, (iv) spectators who have both cats and dogs, and (v) spectators who have animals other than cats and dogs. If the number of spectators who have dogs is the greatest, the game processor 121 may determine to display, in the virtual space FD, a video advertisement (e.g. “Tasty Dog Food”) AD that targets users who have dogs.

In one example, if the spectator information WTinf includes the residential area of each spectator or the location area of each spectator apparatus, the game processor 121 may determine video advertisements AD to be displayed in the virtual space FD, based on the residential area of each spectator. In this case, for example, it is possible to reduce display of video advertisements AD in the virtual space FD for commodities that are not supplied to areas or countries where the greatest number of spectators live. Furthermore, if the spectator information WTinf includes the nationality of each spectator, the game processor 121 may change the language to be displayed in video advertisements AD or the language to be spoken in video advertisements AD in accordance with the nationality to which the greatest number of spectators belong.

In Modification 1, the same effects as those in the foregoing embodiment are obtained.

### Modification 2

In the foregoing embodiment and in Modification 1, an example has been described in which video advertisements AD to be displayed in the virtual space FD are determined based on only one item (e.g., age groups of spectators) included in the spectator information WTinf. However, the present disclosure is not limited to such an aspect.

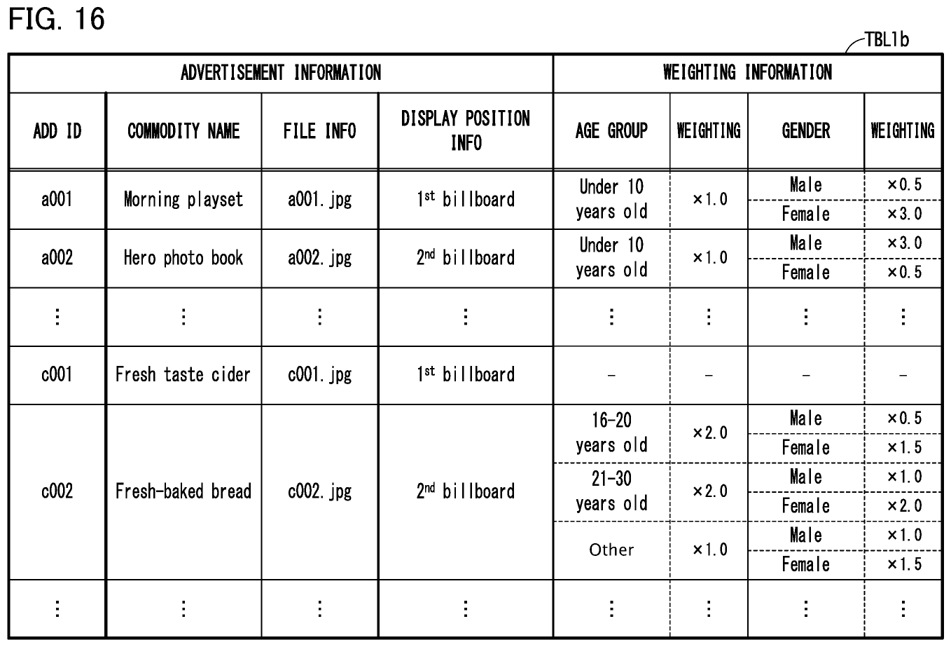

In one example, the game processor 121 may determine a video advertisement AD to be displayed in the virtual space FD from among one or more video advertisements AD, based on (i) relevant information indicating relationships between one or more video advertisements AD and the attributions of each of the spectators, and (ii) the spectator information WTinf acquired by the spectator information acquirer 123. In one example, the relevant information may be index values, each of which indicates how much the attributions of each of the spectators correlate with those of the target audience of the advertisement. As shown in FIG. 16, each index value may be a weight for each item of the attributions of the spectator, such as an age group and gender.

FIG. 16 is an example of a data structure of an advertisement management table TBL1b according to Modification 2.

The advertisement management table TBL1b includes records that correspond one-to-one with advertisements, which are obtained from one or more advertisers. Each record in the advertisement management table TBL1b includes advertisement information and weighting information (an example of “relevant information”).

The advertisement information is identical to that described in FIG. 12. In one example, the advertisement information includes an advertisement ID, a commodity name, file information, and display position information, description of which will be omitted since they have been described for FIG. 12.

In one example, the weighting information includes an age group of a spectator, a weighting for the age group thereof, and a weighting for gender thereof. In the example shown in FIG. 16, a field for the weighting information includes sub-records, the number of which has the number of combinations of (i) age groups to which a value other than “1” is weighted, and (ii) genders to which a value other than “1” is weighted. For example, in the record with an advertisement ID “c002,” there are two fields, one for the age group of the spectator, and the other for the weighting thereof, and each includes three sub-records for “16 to 20 year-olds,” “21 to 30 year-olds,” and “other.” The “other” shown in FIG. 16 refers to age groups other than the specified age group in each record.

There are two fields, one for gender of the spectator, the other for a weighting thereof, and each includes two sub-records. One of the two sub-records corresponds to a sub-record for males, and the other corresponds to a sub-record for females. If the weighting for males is identical to that for females, each of the two fields, one for gender of the spectator, and the other for a weighting thereof, may include one sub-record that does not distinguish between males and females for the age group.

In the example shown in FIG. 16, the age group with the greater weighting value is closer to the age group of the target audience of the advertisement than that with the lesser weighting value. Similarly, the gender with the greater weighting value is closer to the gender of the target audience of the advertisement than that with a lesser weighting value. In other words, the attributions of a spectator with a greater weighting value is closer to the attributions of the target audience of the advertisement than one with a lesser weighting value.

Here, the dash (“-”) shown in FIG. 16 indicates that nothing is weighted. Furthermore, in each record, if the “other” is not specified in a field for the age groups, the dash indicates that nothing is weighted in the combinations of (i) age groups other than the specified age group and (ii) gender. Age groups and gender that are not weighted are interpreted as a weighting value being “1.”

Next, description will be given of an example method of determining a video advertisement AD to be displayed in the virtual space FD using the advertisement management table TBL1b.

In one example, the game processor 121 calculates, for each spectator, points of relationships between the attributions of a spectator and the target audience of the advertisement, based on the advertisement management table TBL1b and the spectator information WTinf. The generation of points is repeated for each video advertisement AD. Then, the game processor 121 determines to display, in the virtual space FD, for each display position specified by the display position information, the video advertisement AD with the greatest number of points.

Hereinafter, specific examples of the method of calculating points will be described under the assumption that spectators include (i) 10 males under 10 years old, and (ii) 40 females from 16 to 20 years old. For simplicity, the assumption will be made in which a video advertisement to be displayed in the virtual space FD is determined from among the four video advertisements the advertisements ID of which correspond to “a001,” “a002,” “c001,” and “c002.”

In one example, in a video advertisement for the “Morning Playset” with the advertisement ID “a001,” a weighting value for males under 10 years old is obtained by multiplying the weighting value “1.0” for the age group by the weighting value for the males “0.5.” A weighting value for females from 16 to 20 years old is “1” because weighting is not specified. Accordingly, points of the video advertisement AD for the “Morning Playset” is “45,” which is obtained as follows: The weighting value “0.5” for males under 10 years old is multiplied by the number of males thereof “10,” which is “5.” The weighting value “1” for females from 16 to 20 years old is multiplied by the number of females thereof “40,” which is “40.” Then both are added up to be “45 (=1.0×0.5×10+1.0×40).”

Points other than the video advertisement AD for the “Morning Playset” are calculated similarly to those for the “Morning Playset.” In one example, points for a video advertisement AD for the “Hero Photo Book” with the advertisement ID “a002” is “70 (=1.0×3.0×10+1.0×40).” Points for a video advertisement AD for the “Fresh Taste Cider” with the advertisement ID “c001” is to be “50 (=1.0×10+1.0×40).” Points for a video advertisement AD for the “Fresh-baked Bread” with the advertisement ID “c002” is to be “130 (=1.0×1.0×10+2.0×1.5×40).”

In the above-mentioned numerical example, among the video advertisements AD, the display position, each of which is at the first billboard (BDa shown in FIG. 1), the video advertisement AD “Fresh Taste Cider” has points “50,” which is greater than the video advertisement AD “Morning Playset” having points “45.” For this reason, the game processor 121 determines to display the video advertisement AD “Fresh Taste Cider” on the billboard BDa. Furthermore, among the video advertisements AD, the display position of each of which is at the second billboard (BDb shown in FIG. 1), the video advertisement AD “Fresh-baked Bread” has points “130,” which is higher than the video advertisement AD “Hero Photo Book” having points “70.” For this reason, the game processor 121 determines to display the video advertisement AD “Fresh-baked Bread” on the billboard BDb.

The data structure of the advertisement management table TBL1b is not limited to the example shown in FIG. 16. In one example, there may be one or more than three items to be weighted. Specifically, in one example, there are items (e.g., age group, gender, residential area, hobbies and interests) that correspond to the spectator information WTinf, which has been described for FIG. 10. From among these items, one or more of the items may be weighted.

The weighting value may be “0”. In one example, in an advertisement that does not target spectators under 10 years old, the weighting value for the age group under 10 years old may be “0.” If there are many spectators with attributions different from those of the target audience of the advertisement, the advertisement will be less effective. Accordingly, the weighting value for the attributions different from the attributions of the target audience of the advertisement is set to “0.” This prevents display of video advertisements that target users with attributions different from those of spectators (less effective advertisements) in the virtual space FD.

In an example of the weighting information, if the number of spectator apparatuses is weighted additionally, it is set to “0” for the weighting value for the number of spectator apparatuses other than the desired number thereof. During a period when the number of spectator apparatuses is not the desired number thereof, display of video advertisements AD in the virtual space FD is prevented. Specifically, for example, in the weighting information for “Fresh-baked Bread” with the advertisement ID “c002,” a weighting of “0” may be applied to the number of spectator apparatuses of 50 or less. In this case, during a period when the number of spectator apparatuses is 50 or less, the video advertisement AD “Fresh-baked Bread” is not selected as a video advertisement AD to be displayed in the virtual space FD because the points are always “0.”

In one example, if the spectator information “WTinf” includes information indicating that the spectator has positive feelings toward the distribution-use video DMV, a weighting value greater than “1” may be applied to such a spectator. The information indicating a positive feeling may be information indicating that the like button BTgd was clicked. In one example, the game processor 121 may set the weighting value for a spectator who clicked the like button BTgd to be a times the weighting value for a spectator who does click it, and has the same attribution as that of the spectator (age group, gender, etc.). In one example, a is a numerical value greater than “1,” and it indicates a weighting for the like button BTgd being clicked. Specifically, the weighting value for females who are 16 to 20 years old and who do not click the like button BTgd is “1” for the video advertisement AD “Fresh Taste Cider,” and it is “3 (=2×1.5)” for the video advertisement AD “Fresh-baked Bread.” In contrast, the weighting value for females who are 16 to 20 years old and who clicked the like button BTgd is “1×α” for the video advertisement AD “Fresh Taste Cider,” and it is “3×α” for the video advertisement AD “Fresh-baked Bread.”

A spectator who has clicked the like button BTgd is less likely to stop watching the distribution-use video DMV than one who does not. For this reason, if a click of the like button BTgd is weighted, as compared to if it is not, advertisements, which target users with attributions closer to those of spectators who watch the video of a computer baseball game to the end, are displayed in the virtual space FD.

In one example, if the spectator information WTinf includes information indicating that the spectator has a negative feeling (e.g., dislike, not enjoyable, and disagree) toward the distribution-use video DMV, a weighting value less than “1” may be applied to such a spectator. In this case, a button for expressing a spectator's negative feelings toward the distribution-use video DMV may be displayed on the video distribution screen DS.

In Modification 2, the same effects as those in the foregoing embodiment, and in Modification 1, are obtained.

Furthermore, in Modification 2, video advertisements AD to be displayed in the virtual space FD are determined by looking at multiple items such as age groups and gender of spectators. Accordingly, advertisements that target users with attributions closer to those of spectators are displayed in the virtual space FD. In other words, in Modification 2, the effect of the advertisements displayed in the virtual space FD is enhanced as compared to a case in which advertisements to be displayed in the virtual space FD is determined based only on one of the attributions of the spectators.

In one example, if video advertisements AD to be displayed in the virtual space FD are determined based on (i) one item (e.g., age group of a spectator) included in the spectator information WTinf, and (ii) a weighting value for that one item, as compared if the one item is not weighted, commodities are advertised to spectators with the attributions desired by the advertiser.

### Modification 3

In the foregoing embodiments and in Modifications 1 and 2, an example has been described in which on the bases of the display position information, it is specified that an advertisement ADi is to be displayed on which of the first billboard and the second billboard. However, the present disclosure is not limited to such an aspect.

In one example, the display position information may simply indicate a billboard without distinguishing between the first and second billboards. Alternatively, the display position information may be omitted.

In one example, when Modification 3 is applied to the foregoing Modification 2, among four video advertisements AD: “Morning Playset,” “Hero Photo Book,” “Fresh Taste Cider,” and “Fresh-baked Bread,” two video advertisements AD with the greatest number of points may be determined to be displayed in the virtual space FD. Alternatively, among those, the video advertisement AD with the greatest number of points may be determined to be displayed on both billboards BDa and BDb.

In the same numerical example as Modification 2, among the four video advertisements AD, the video advertisement AD “Fresh-baked Bread” has points “130,” which is the highest. The video advertisement AD “Hero Photo Book” has points “70,” which is the second highest. Accordingly, the game processor 121 may determine to display, on the billboards BDa and BDb, these two video advertisements AD “Fresh-baked Bread” and “Hero Photo Book.” Alternatively, the game processor 121 may determine to display, on both the billboards BDa and BDb, the video advertisement AD “Fresh-baked Bread.”

If two video advertisements AD “Fresh-baked Bread” and “Hero Photo Book” are determined to be displayed on the billboards BDa and BDb, these two may be displayed on the billboards BDa and BDb. Alternatively, the following (i) and (ii) may be repeated: (i) a first period during which the video advertisement AD “Fresh-baked Bread” is displayed on both billboards BDa and BDb; and (ii) a second period during which the video advertisement AD “Hero Photo Book” is displayed on both billboards BDa and BDb. The first and second periods may have the same length, or they may have different lengths based on points (e.g., 130 seconds for the first period, and 70 seconds for the second period).

In Modification 3, the same effects as those in the foregoing embodiment, and in Modifications 1 and 2, are obtained.

Modification 4 In the foregoing embodiment and in Modifications 1 to 3, an example has been described in which the game apparatus 10 acquires, from the advertisement management server 50, the advertisement management table TBL1, TBL1a, or TBL1b. However, the present disclosure is not limited to such an aspect.

In one example, the advertisement management table TBL1, TBL1a, or TBL1b, and the advertisement file may be included in the computer game program PRg. The advertisement management server 50 may access the game apparatus 10 via the network NW to update the advertisement management table TBL1 and others including the computer game program PRg.

In Modification 4, the same effects as those in the foregoing embodiment, and in Modifications 1 to 3, are obtained.

### Modification 5

In the foregoing embodiment and in Modifications 1 to 4, an example aspect has been given in which the game apparatus 10 acquires the spectator information WTinf at time t1 after the predetermined time Ta has elapsed from the distribution start time t0. However, the present disclosure is not limited to such an aspect. In one example, the game apparatus 10 may acquire the spectator information WTinf at the start of a predetermined inning in a computer baseball game (e.g., at the start of the third inning). In Modification 5, the same effects as those in the foregoing embodiment, and in Modifications 1 to 4, are obtained.

### Modification 6

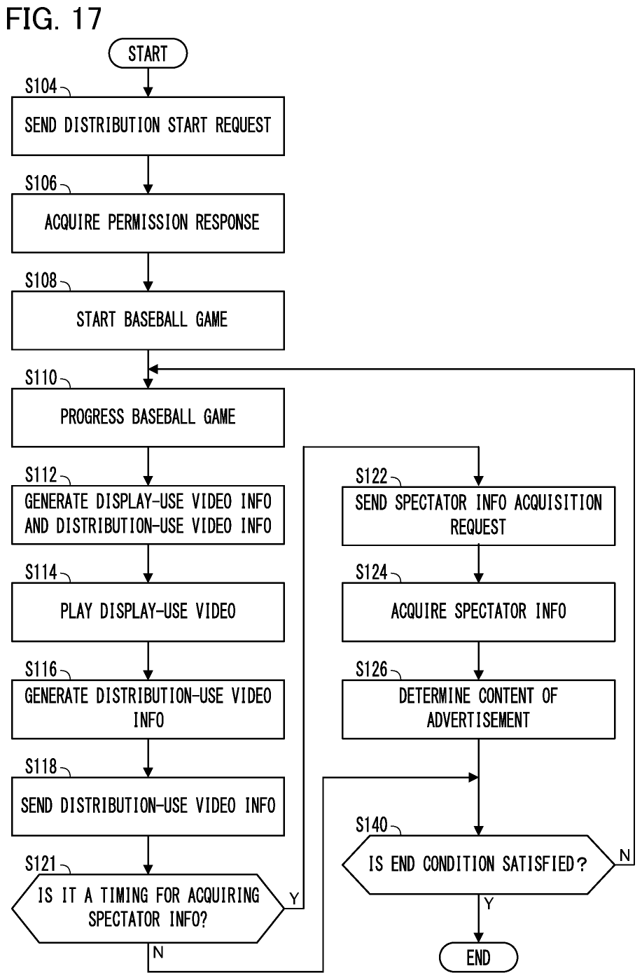

In the foregoing embodiment and in Modifications 1 to 5, an example aspect has been given in which a video advertisement AD determined once, as a video advertisement AD to be displayed in the virtual space FD, is not changed until the end of the computer baseball game. However, the present disclosure is not limited to such an aspect. In one example, a video advertisement AD to be displayed in the virtual space FD may be determined repeatedly at intervals, as shown in FIG. 17.

FIG. 17 is a flowchart showing an example of procedures for the game apparatus 10 according to Modification 6.

Detailed description will be omitted for procedures similar to those described in FIG. 14. In the procedures shown in FIG. 17, in one example, a series of steps S110 to step S118 serves as a series of steps S110 to S118, and a series of steps S130 to S138 shown in FIG. 14. Furthermore, in the procedures shown in FIG. 17, the determination procedure at step S121 is executed instead of that at step S120 shown in FIG. 14. The remaining procedures shown in FIG. 17 are identical to those shown in FIG. 14. In one example, step S110 is executed after step S108, or it is executed when the result of the determination at step S140 is negative.

When content of each of the advertisements to be displayed in the virtual space FD has not yet been determined (e.g., when step S126 has not yet been executed), a series of steps S110 to S118 shown in FIG. 17 is identical to that shown in FIG. 14. In addition, when content of each of the advertisements to be displayed in the virtual space FD is determined (e.g., when step S126 is executed even once), a series of steps S10 to S118 shown in FIG. 17 is identical to a series of steps S130 to S138 shown in FIG. 14. In one example, after step S118, the video supplier 122 moves the process to step S121.

At step S121, the spectator information acquirer 123 determines whether the current time is the timing for acquiring the spectator information WTinf. In one example, the spectator information acquirer 123 determines whether the predetermined time Ta has elapsed from the distribution start time t0 or the previous timing for acquisition. When the result of the determination at step S121 is negative, the spectator information acquirer 123 moves the process to step S140. When the result of the determination at step S121 is positive, the spectator information acquirer 123 moves the process to step S122.

The series of steps S122 to S126 is identical to that shown in FIG. 14. In step S126 shown in FIG. 17, the game processor 121 determines video advertisements AD (content of advertisements) to be displayed in the virtual space FD, based on the spectator information WTinf acquired by the spectator information acquirer 123 at the latest timing for acquisition. After step S126, the game processor 121 moves the process to step S140.

At step S140, the game processor 121 determines whether a predetermined end condition is satisfied, for example, the baseball game has ended. When the result of the determination at step S140 is negative, the game processor 121 returns the process to step S110. When the result of the determination at step S140 is positive, the game processor 121 ends the processes shown in FIG. 17. Thus, in Modification 6, content of advertisements AD to be displayed in the virtual space FD (content of advertisements) are determined every time the predetermined time Ta elapses.

The procedures for the game apparatus 10 according to Modification 6 is not limited to the example shown in FIG. 17. In one example, an interval from the distribution start time t0 to the first timing of acquiring the spectator information WTinf may differ from an interval from the time t0 to the second timing or thereafter. In one example, a timing of acquiring the spectator information WTinf may be at the start of a predetermined inning, such as the third inning, the fifth inning, or the seventh inning. In one example, step S121 may be executed before S110. In this case, a series of steps S110 to S118 may be executed when the result of the determination at step S121 is negative, or it may be executed after step S126.

Thus, in Modification 6, the spectator information acquirer 123 repeatedly acquires the spectator information WTinf at intervals. The game processor 121 determines video advertisements AD to be displayed in the virtual space FD every time the spectator information acquirer 123 acquires the spectator information WTinf. Accordingly, in Modification 6, video advertisements AD to be displayed in the virtual space FD are determined accordingly based on attributions of spectators (e.g., age groups and gender) that change during the computer baseball game.

### Modification 7

In the foregoing embodiment, and in Modifications 1 to 6, a “computer baseball game” has been given as an example of a “computer game,” but the present disclosure is not limited to such an aspect. A freely selected computer game may be employed as the “computer game” according to the present disclosure.

### Modification 8

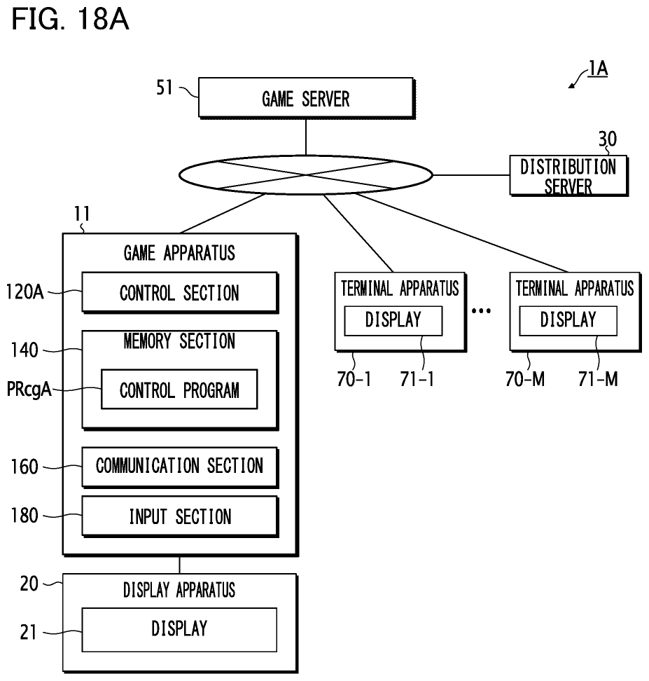

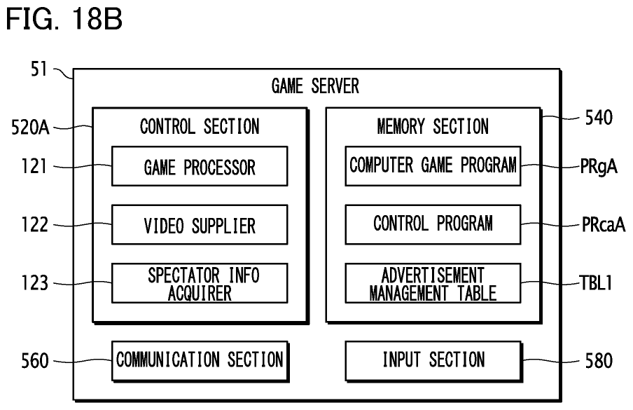

In the foregoing embodiment, and in Modifications 1 to 7, an example has been given in which the predetermined computer game is executed at the user's game apparatus 10, but the present disclosure is not limited to such an aspect. In one example, as shown in FIGS. 18A and 18B, the predetermined computer game may be executed at a game server 51.

FIG. 18A is a diagram showing an overview of a game system 1A according to Modification 8. FIG. 18B is a functional block diagram of an example of the game server 51 shown in FIG. 18A.

The game system 1A shown in FIG. 18A includes the game server 51 instead of the advertisement management server 50 shown in FIG. 1, and a game apparatus 11 instead of the game apparatus 10 shown in FIG. 1. The rest of the configuration of the game system 1A is identical to the game system 1 shown in FIG. 1. In one example, the game system 1A includes the game server 51 that executes the predetermined computer game, the game apparatus 11, the display apparatus 20 corresponding to the game apparatus 11, the distribution server 30, and a plurality of M terminal apparatuses 70 (70-1 to 70-M). The M is a natural number of 1 or more. The game apparatus 11, the distribution server 30, the game server 51, and a plurality of M terminal apparatus 70 are connected communicably to one another via a network NW.

The game server 51 (another example of a “game apparatus”) executes the predetermined computer game. Furthermore, the game server 51 serves as the advertisement management server 50 shown in FIG. 1. In one example, as shown in FIG. 18B, the game server 51 includes a control section 520A that controls each part of the game server 51, the memory section 540 that stores various information, the communication section 560 that communicates with external apparatuses including the game apparatus 11, the distribution server 30, and the terminal apparatus 70, and an input section 580 that receives administrator's inputs made to the game server 51.

In one example, the control section 520A includes the game processor 121, the video supplier 122, and the spectator information acquirer 123, all of which are described in FIG. 4 and other drawings. In one example, the memory section 540 includes a computer game program PRgA (an example of a “computer program”) for executing the predetermined computer game, a control program PRcaA for controlling each part of the game server 51, and the advertisement management table TBL1. The memory section 540 may store the advertisement management table TBL1a or TBL1b instead of the advertisement management table TBL1.

As shown in FIG. 18A, the game apparatus 11 includes a control section 120A, the memory section 140 that stores a control program PRcgA and other programs of the game apparatus 11, and the communication section 160 that communicates with external apparatuses including the distribution server 30 and the game server 51, and the input section 180 that receives user's inputs made to the game apparatus 11. On the bases of display-use video information GMVinf generated by the game server 51, the control section 120A shows a display-use video GMV relating to the predetermined computer game on the display 21, which is included in the display apparatus 20 corresponding to the game apparatus 11.

In one example, the hardware configuration of the game server 51 is identical to that of the advertisement management server 50 including an input apparatus that functions as the input section 580, as shown in FIG. 9. In one example, as described in FIG. 9, the memory 54 functions as the memory section 540. Accordingly, in Modification 8, the memory 54, which functions as the memory section 540 storing the computer game program PRgA, corresponds to a non-transitory recording medium on which the computer game program PRgA is recorded. In one example, the memory 54 is a computer-readable recording medium. In Modification 8, the “storage medium” on which the computer game program PRgA is recorded is a storage device provided in an external apparatus external to the game server 51. In one example, the “storage medium” may be a storage device that is configured to record therein the computer game program PRgA. The storage device may be included in a server apparatus external to the game server 51 and distributes the computer game program PRgA.

In Modification 8, the same effects as those in the foregoing embodiment, and in Modifications 1 and 7, are obtained.

### Modification 9

In the foregoing embodiment and in Modifications 1 to 7, an example has been given of a game apparatus 10 including the spectator information acquirer 123, but the present disclosure is not limited to such an aspect. In one example, the advertisement management server 50 may include the spectator information acquirer 123. In this case, the advertisement management server 50 may supply, to the game apparatus 10, spectator information WTinf acquired from the distribution server 30. Alternatively, based on the advertisement management table TBL1 and the spectator information WTinf, the advertisement management server 50 may determine video advertisements AD to be displayed in the virtual space FD, and it may supply information indicative of the determined video advertisements AD to the game apparatus 10. Furthermore, in the game system 1A shown in FIG. 18A, the game processor 121 and the video supplier 122 may be included in the game apparatus 11. In Modification 9, the same effects as those in the foregoing embodiment, and in Modifications 1 and 7 are obtained.

### 3. APPENDICES

From the foregoing description, the present disclosure can be understood as follows:

### Appendix 1

A recording medium according to an aspect of the present disclosure is a non-transitory computer-readable recording medium having instructions stored therein that cause at least one processor (e.g., a processor 12) of a game apparatus (e.g., a game apparatus 10) to: communicate with a distribution system configured to distribute videos to a plurality of terminal apparatuses; progress a computer game; generate, based on a progress of the computer game, video information (display-use video information GMVinf) that is used to play a video of the computer game (e.g., a display-use video GMV) indicating a state of a virtual space of the computer game; supply a distribution video (a distribution-use video DMV) based on the video information to the distribution system; acquire spectator information (e.g., spectator information WTinf) from the distribution system, the spectator information relating to at least one spectator apparatus that is a part of the plurality of terminal apparatuses, and receives the distribution video from the distribution system; and control content of an advertisement to be displayed in the virtual space, based on the spectator information.

According to this aspect, content of an advertisement to be displayed in the virtual space is determined based on the spectator information relating to a spectator apparatus. The spectator apparatus corresponds to a terminal apparatus that plays a distribution video received from the game apparatus via the distribution system. For this reason, determining content of an advertisement to be displayed in the virtual space based on the spectator information is the same as determining the content of the advertisement to be displayed in the virtual space by looking at the presence of a spectator of the computer game. Accordingly, according to this aspect, the content of the advertisement to be displayed in the virtual space is controlled by looking at not only a user playing the computer game, but also a spectator watching the video thereof.

In this aspect, the “state of a virtual space” may relate to a game element in the virtual space, or it may relate to sound in the virtual space, or it may be some or all of the states.

The “game element in the virtual space” may be disposed at any position in the virtual space. The “game element” may be controlled by a program of the game apparatus (a processor executed by the program). Alternatively, the “game element” may be a character relating to the computer game, an object of the computer game, an environmental component of the virtual space, or it may be some or all of these. The “state relating to a game element” may be a position of a game element in the virtual space, or it may be the shape, pattern, or color of the game element, or it may be a direction or a speed of movement of the game element in the virtual space, or it may be some or all of these.

The “sound in the virtual space” may be output or heard at any position in the virtual space, or it may be associated with a game element in the virtual space, or it may be both of these. The “sound” may also be voice (audio).

In this aspect, the “video information” may indicate a game image (a still image indicative of the state of the virtual space) that is updated every unit period of time in real time, or it may indicate a set of game images that correspond one-to-one to unit periods of time (information indicative of a set of game images accumulated over multiple unit periods of time). Alternatively, the “video information” may be obtained by adding information on sound in the virtual space to information described above.

In this aspect, the “spectator information” may be user information on a user that watches the distribution video (a user of the spectator apparatus), or it may be apparatus information on the spectator apparatus, or it may be information using both of these.

The “user information” may be user attribution information indicative of an attribution of the user.

The “user attribution information” may be information associated with each user, for example, item information common to each user. The “item information common to each user” may indicate some or all of age, residential area, hobbies and interests of each user.

In one example, if the distribution video is watchable for a user who are not registered for a video distribution service that is distributed from the distribution system, the “user information” may include the number of users who have registered with the video distribution service among users watching the distribution video.

In one example, the “apparatus information” may be the number of spectator apparatuses playing the distribution video, or it may be apparatus attribution information indicative of an attribution of the spectator apparatus, or it may be information using both of these.

In one example, the “apparatus attribution information” may indicate some or all of the following: a type, a location area, and an operating system of the spectator apparatus; and an application that is used to play the distribution video.

In this aspect, the “advertisement” may be a still image or moving images relating to a target advertisement, such as a product or a service, which is displayed on a game element in the virtual space, or it may be an audio relating to the advertisement, which is output from the game element in the virtual space, or it may be some or all of these.

### Appendix 2

In the recording medium according to Appendix 1, the spectator information includes user attribution information indicating an attribution of a user of the at least one spectator apparatus.

According to this aspect, the same effects as those in Appendix 1 are obtained. Specifically, content of an advertisement to be displayed in the virtual space is determined based on an attribution of the user watching the distribution video in real time.

### Appendix 3

In the recording medium according to Appendix 2, the user attribution information includes hobbies and interests of the user of the at least one spectator apparatus.

According to this aspect, the same effects as those in Appendix 2 are obtained. Specifically, content of an advertisement to be displayed in the virtual space is determined based on hobbies and interests of the user watching the distribution video in real time.

In this aspect, for example, the “hobbies and interests” may be one or both of (i) the user's tendencies in browsing the Internet, and (ii) the user's tendencies in using services on the Internet. Furthermore, in one example, the “hobbies and interests” may be hobbies obtained from a user when the user registers for user registration for watching the distribution video based on the video information.

In this aspect, for example, the “information indicating hobbies and interests” may be one or both of (i) browsing history on the Internet by the user's terminal apparatus, and (ii) usage history of services on the Internet, or it may be analysis results of the user's interests based on one or both of the browsing history and the usage history. Furthermore, in one example, the “information indicating hobbies and interests” may be information obtained from a user when the user registers for user registration for watching the distribution video based on the video information.

### Appendix 4

In the recording medium according to any one of Appendices 1 to 3, the instructions cause the at least one processor to determine, from among one or more advertisements, an advertisement to be displayed in the virtual space, based on: (i) relevant information indicating relationships between the one or more advertisements, and an attribution of a user: and (ii) the spectator information.

According to this aspect, the same effects as those in any one of Appendices 1 to 3 are obtained. Furthermore, according to this aspect, content of an advertisement to be displayed in the virtual space is determined by looking at the relevant information between the advertisement and the attribution, such as age group and gender of the user. In one example, according to this aspect, an advertisement that targets users with an attribute closer to that of the user is displayed in the virtual space.

In this aspect, for example, the “relevant information” may be an index value indicating how much an attribution of a user correlates with that of a user that is targeted for the advertisement.

### Appendix 5

In recording medium according to any one of Appendices 1 to 4, the spectator information includes a location area of the at least one spectator apparatus.

According to this aspect, the same effects as those in any one of Appendices 1 to 4 are obtained. According to this aspect, in one example, content of an advertisement to be displayed in the virtual space is determined based on a location area of the spectator apparatus receiving the distribution video in real time. In one example, the location area of the spectator apparatus corresponds to a location area of the user who owns the spectator apparatus. In other words, according to this aspect, content of an advertisement to be displayed in the virtual space is determined based on the location area of the user watching the distribution video in real time. Accordingly, in this aspect, it is possible to reduce display of video advertisements in the virtual space for commodities that are not supplied to areas or countries where the greatest number of users live.

### Appendix 6

In the recording medium according to any one of Appendices 1 to 5, the spectator information includes a number of the at least one spectator apparatus.

According to this aspect, the same effects as those in any one of Appendices 1 to 5 are obtained. According to this aspect, for example, content of an advertisement to be displayed in the virtual space is determined based on the number of spectator apparatuses receiving the distribution video in real time.

### Appendix 7

A computer-implemented control method according to an aspect of the present disclosure includes: communicating with a distribution system configured to distribute videos to a plurality of terminal apparatuses; progressing a computer game, generating, based on a progress of the computer game; video information that is used to play a video of the computer game indicating a state of a virtual space of the computer game; supplying a distribution video based on the video information to the distribution system; acquiring spectator information from the distribution system, the spectator information relating to at least one spectator apparatus that is a part of the plurality of terminal apparatuses, and receives the distribution video from the distribution system; and controlling content of an advertisement to be displayed in the virtual space, based on the spectator information.

According to this aspect, the same effects as those of Appendix 1 are obtained.

### Appendix 8

A game apparatus according to an aspect of the present disclosure includes: at least one memory storing instructions and at least one processor that implements the instructions to: communicate with a distribution system configured to distribute videos to a plurality of terminal apparatuses; progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

According to this aspect, the same effects as those of Appendix 1 are obtained.

### Appendix 9

A game system according to an aspect of the present disclosure includes: a distribution system configured to distribute videos to a plurality of terminal apparatuses; and a game apparatus configured to communicate with the distribution system, in which the game apparatus includes: at least one memory storing instructions; and at least one processor that implements the instructions to: progress a computer game; generate, based on a progress of the computer game, video information that is used to play a video of the computer game indicating a state of a virtual space of the computer game; supply a distribution video based on the video information to the distribution system; acquire spectator information from the distribution system, the spectator information relating to at least one spectator apparatus that is a part of the plurality of terminal apparatuses, and receives the distribution video from the distribution system; and control content of an advertisement to be displayed in the virtual space, based on the spectator information.

According to this aspect, the same effects as those of Appendix 1 are obtained.

### DESCRIPTION OF REFERENCE SIGNS

1, 1A . . . game system, 10 . . . game apparatus, 11 . . . game apparatus, 12 . . . processor, 14 . . . memory 16 . . . communication apparatus, 18 . . . input apparatus, 20 . . . display apparatus, 21 . . . display, 30 . . . distribution server, 32 . . . processor, 34 . . . memory, 36 . . . communication apparatus, 50 . . . advertisement management server, 51 . . . game server, 52 . . . processor, 54 . . . memory, 56 . . . communication apparatus, 70 . . . terminal apparatus, 71 . . . display, 120, 120A . . . control section, 121 . . . game processor, 122 . . . video supplier, 123 . . . spectator information acquirer, 140 . . . memory section, 160 . . . communication section, 180 . . . input section, 320 . . . control section, 321 . . . video acquirer, 322 . . . video distributor, 324 . . . spectator information supplier, 340 . . . memory section, 360 . . . communication section, 520, 520A . . . control section, 521 . . . supplier, 540 . . . memory section, 560 . . . communication section, and 580 . . . input section.

What is claimed is:

1. A non-transitory computer-readable recording medium having instructions stored therein that cause at least one processor of a game apparatus to:
communicate with a distribution system configured to distribute videos to a plurality of terminal apparatuses;
progress a computer game;
generate, based on a progress of the computer game, video information that is used to play a video of the computer game indicating a state of a virtual space of the computer game;
supply a distribution video based on the video information to the distribution system;
acquire spectator information from the distribution system, the spectator information relating to at least one spectator apparatus that is a part of the plurality of terminal apparatuses, and receives the distribution video from the distribution system; and
control content of an advertisement to be displayed in the virtual space, based on the spectator information.

2. The recording medium according to claim 1,
wherein the spectator information includes user attribution information indicating an attribution of a user of the at least one spectator apparatus.

3. The recording medium according to claim 2,
wherein the user attribution information includes hobbies and interests of the user of the at least one spectator apparatus.

4. The recording medium according to claim 1,
wherein the instructions cause the at least one processor to determine, from among one or more advertisements, an advertisement to be displayed in the virtual space, based on:
relevant information indicating relationships between the one or more advertisements, and an attribution of a user; and
the spectator information.

5. The recording medium according to claim 1,
wherein the spectator information includes a location area of the at least one spectator apparatus.

6. The recording medium according to claim 1,
wherein the spectator information includes a number of the at least one spectator apparatus.

7. A computer-implemented control method comprising:
communicating with a distribution system configured to distribute videos to a plurality of terminal apparatuses;
progressing a computer game;
generating, based on a progress of the computer game, video information that is used to play a video of the computer game indicating a state of a virtual space of the computer game;
supplying a distribution video based on the video information to the distribution system;
acquiring spectator information from the distribution system, the spectator information relating to at least one spectator apparatus that is a part of the plurality of terminal apparatuses, and receives the distribution video from the distribution system; and
controlling content of an advertisement to be displayed in the virtual space, based on the spectator information.

8. A game system comprising:
a distribution system configured to distribute videos to a plurality of terminal apparatuses; and
a game apparatus configured to communicate with the distribution system,
wherein the game apparatus includes:
at least one memory storing instructions; and
at least one processor that implements the instructions to:
progress a computer game;
generate, based on a progress of the computer game, video information that is used to play a video of the computer game indicating a state of a virtual space of the computer game;
supply a distribution video based on the video information to the distribution system;
acquire spectator information from the distribution system, the spectator information relating to at least one spectator apparatus that is a part of the plurality of terminal apparatuses, and receives the distribution video from the distribution system; and
control content of an advertisement to be displayed in the virtual space, based on the spectator information.
